(19) United States
(12) Patent Application Publication
(10) Pub. No.: US 2025/0196330 A1
(43) Pub. Date: Jun. 19, 2025

(54) ARTICLEMETHOD FOR CONTROLLING ARTICULATED ROBOT, ROBOT SYSTEM, RECORDING MEDIUM, AND METHOD FOR MANUFACTURING OBJECT

(71) Applicants: LAUREL BANK MACHINES CO., LTD., Tokyo (JP); LAUREL MACHINERY CO., LTD., Osaka (JP); LAUREL PRECISION MACHINES CO., LTD., Osaka (JP)

(72) Inventors: Tomohide HANDA, Tokyo (JP); Hideyuki NAKANISHI, Tokyo (JP); Satoshi TANIMURA, Shimoina-gun (JP)

(73) Assignees: LAUREL BANK MACHINES CO., LTD., Tokyo (JP); LAUREL MACHINERY CO., LTD., Osaka (JP); LAUREL PRECISION MACHINES CO., LTD., Osaka (JP)

(21) Appl. No.: 19/065,050

(22) Filed: Feb. 27, 2025

Related U.S. Application Data
(63) Continuation of application No. PCT/JP2023/029630, filed on Aug. 16, 2023.

(30) Foreign Application Priority Data
Aug. 30, 2022 (JP) 2022-136884
May 25, 2023 (JP) 2023-086110

(51) Int. Cl. B25J 9/16; B25J 9/04

(52) U.S. Cl. CPC B25J 9/1607; B25J 9/042; B25J 9/1687

(57) ABSTRACT

A method for controlling an articulated robot with seven or more joints is a method includes repeating unit processing including computation processing and fixation processing. The computation processing is for (i) computing a displacement of each of the seven or more joints by use of computation of inverse kinematics; and (ii) updating a joint value of each of the seven or more joints based on the computed displacement. The fixation processing is performed on a joint in a specific state from among the seven or more joints, in which the specific state is determined based on a joint value of the joint in the specific state. When the fixation processing is performed, the computation processing includes changing, from among the seven or more joints, joint values of respective joints in a non-specific state, without substantially changing the joint value of the joint in the specific state.

### CROSS REFERENCE TO RELATED APPLICATIONS

This Application is a Continuation Application of PCT Application No. PCT/JP2023/029630 filed on Aug. 16, 2023, and is based on and claims priority from (i) Japanese Patent Application No. 2022-136884 filed on Aug. 30, 2022, and (ii) Japanese Patent Application No. 2023-086110 filed on May 25, 2023, the entire contents of each of which are incorporated herein by reference.

### BACKGROUND

### Field of the Invention

This disclosure relates to methods for controlling articulated robots, to robot systems, to recording media, and to methods for manufacturing objects.

### Description of Related Art

A known articulated robot with six degrees of freedom performs humanlike actions. Recent studies have shown an articulated robot with seven or more degrees of freedom, which includes six degrees of freedom and an additional redundant degree of freedom. For example, Patent Document 1 (Japanese Patent Application Laid-Open Publication No. H6-143172) discloses a method for controlling an articulated robot with seven degrees of freedom.

One, some, or all of the joints of a general articulated robot have a range of motion. In one example, inverse kinematics is used to compute displacements of the joints from positions and postures of the robot. If any of the joints is out of the range of motion, a result from computation of inverse kinematics is incorrect, and a correct solution (which satisfies each joint moving within the range of motion) cannot be found. Such an incorrect result from the computation fails to allow the robot to operate correctly.

### SUMMARY

There has been a demand for a reduction in a frequency of incorrect results from computation of inverse kinematics.

A method according to this disclosure is a method for controlling an articulated robot with joints of seven or more. The method includes: repeating unit processing including: computation processing for: computing displacements of the respective joints by use of computation of inverse kinematics, in which the displacements of the respective joints cause the articulated robot to operate; and updating joint values of the respective joints based on the displacements; and fixation processing to be performed on a joint in a specific state from among the joints, in which the specific state is preset and is determined based on a corresponding joint value. When the fixation processing is performed, the computation processing includes changing, from among the joints, joint values of respective joints in a non-specific state, without substantially changing a joint value of the joint in the specific state.

A robot system according to this disclosure includes: an articulated robot with joints of seven or more; and a controller configured to control operation of the articulated robot, in which: the controller includes a motion controller configured to repeat unit processing including: computation processing for: computing displacements of the respective joints by use of computation of inverse kinematics, in which the displacements of the respective joints cause the articulated robot to operate; and updating joint values of the respective joints based on the displacements; and fixation processing to be performed on a joint in a specific state from among the joints, in which the specific state is preset and is determined based on a corresponding joint value. When the fixation processing is performed, the motion controller changes in the computation processing, from among the joints, joint values of respective joints in a non-specific state, without substantially changing a joint value of the joint in the specific state.

A method according to this disclosure is a method for manufacturing an object. The method includes assembling or removing a component by the robot system.

A program according to this disclosure is a program for controlling operation of an articulated robot with joints of seven or more. The program causes a processor to act as a motion controller configured to repeat unit processing including: computation processing for: computing displacements of the respective joints by use of computation of inverse kinematics, in which the displacements of the respective joints cause the articulated robot to operate; and updating joint values of the respective joints based on the displacements; and fixation processing to be performed on a joint in a specific state from among the joints, in which the specific state is preset and is determined based on a corresponding joint value. When the fixation processing is performed, the motion controller changes in the computation processing, from among the joints, joint values of respective joints in a non-specific state, without substantially changing a joint value of the joint in the specific state.

According to this disclosure, frequency is reduced of incorrect results from computation of inverse kinematics.

### BRIEF DESCRIPTION OF THE DRAWINGS

FIG. 1 illustrates description of an outline of the robot system according to an embodiment.

FIG. 2 shows an example of a hardware configuration of a robot controller shown in FIG. 1.

FIG. 3 is a flowchart showing an example of operation of the robot controller shown in FIG. 1.

FIG. 4 is a flow chart showing an example of operation of the robot controller by which a position and posture of the hand of a robot is sequentially changed to one or more target positions and postures.

FIG. 5 is a flowchart showing an example of update processing shown in FIG. 4.

FIG. 6 is a flow chart showing another example of operation of the robot controller when positions and postures of the hand of the robot are sequentially changed to target positions and postures.

FIG. 7 is a flow chart showing another example of operation of the robot controller by which a position and posture of the hand of the robot is sequentially changed to one or more target positions and postures.

FIG. 8 is a flowchart showing an example of first-time update processing shown in FIG. 7.

FIG. 9 illustrates description of a simulation model.

FIG. 10 illustrates description of initial joint values of the simulation model shown in FIG. 9.

FIG. 11 illustrates description of a displacement of the hand used in simulation.

FIG. 12 illustrates description of a Jacobian matrix used in a comparative control method.

FIG. 13 illustrates description of a pseudo-inverse matrix of the Jacobian matrix shown in FIG. 12.

FIG. 14 shows displacements of joints computed using the pseudo-inverse matrix shown in FIG. 13.

FIG. 15 shows final joint values computed based on the displacements of the joints shown in FIG. 14.

FIG. 16 illustrates description of a Jacobian matrix J when joint mechanisms in the specific state are fixed.

FIG. 17 illustrates description of a pseudo-inverse matrix of the Jacobian matrix shown in FIG. 16.

FIG. 18 shows displacements of joints computed using the pseudo-inverse matrix in FIG. 17.

FIG. 19 shows final joint values computed based on the displacements of the joints shown in FIG. 18.

FIG. 20 illustrates description of results of simulation from initial joint values that differ from those shown in FIG. 10.

FIG. 21 illustrates description of a robot according to a first modification.

FIG. 22 illustrates description of an end section according to a second modification.

FIG. 23 illustrates description of “turning.”

### DESCRIPTION OF THE EMBODIMENT

Description will now be given of an embodiment according to this disclosure with reference to the drawings. The dimensions and scales of respective parts in the drawings are different from those of actual products, as appropriate. Since the embodiment described below is an example of this disclosure, various technically limitations are added thereto. However, the scope of this disclosure is not limited to the embodiment unless otherwise stated in the following explanations that this disclosure is specifically limited thereto.

### 1. Embodiment

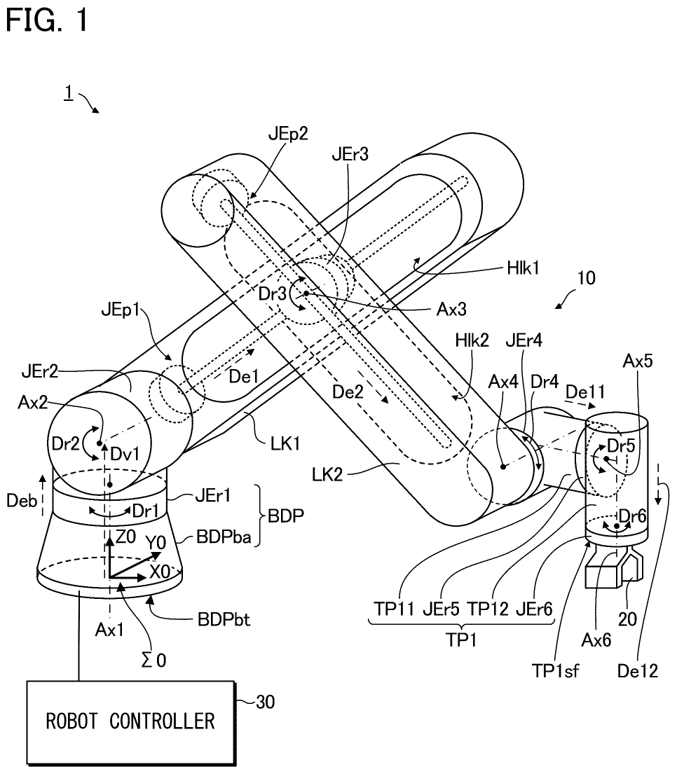

First, an example will now be given of an outline of a robot system 1 according to the embodiment with reference to FIG. 1.

FIG. 1 illustrates description of an outline of the robot system 1 according to the embodiment.

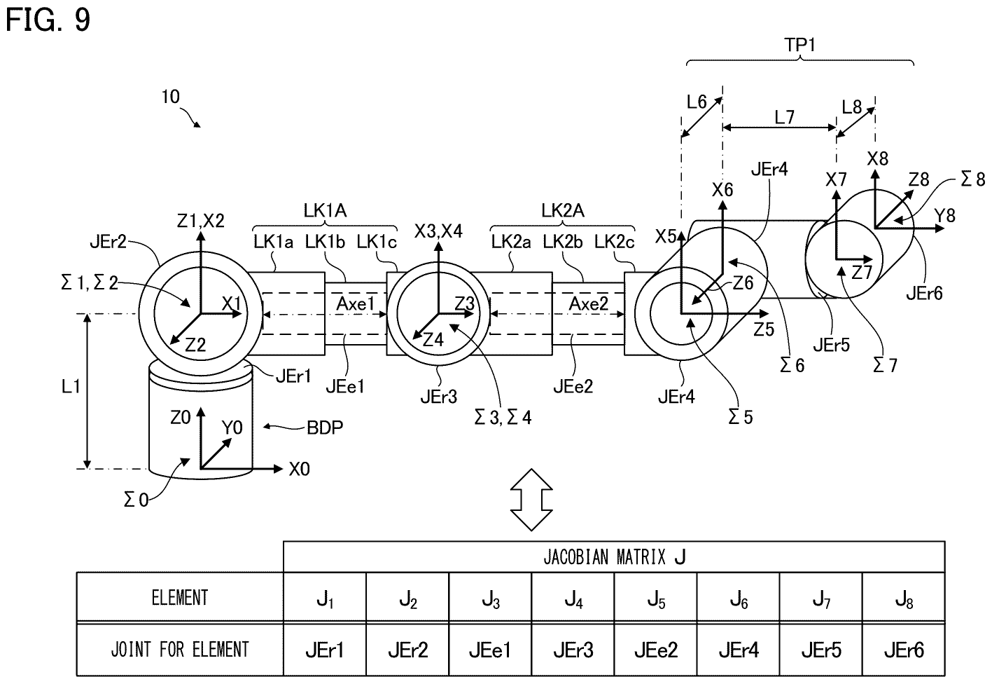

Hereinafter, for convenience of explanation, a reference coordinate system 20 fixed in a physical space is introduced as a base coordinate system of the robot 10. In one example, the reference coordinate system 20 is a three-axis orthogonal coordinate system. The reference coordinate system 20 has an origin at a center of a bottom surface BDPbt of the robot 10 (which will be described later), an X0 axes, a Y0 axes, and a Z0 axes orthogonal to one another. In this embodiment, the reference coordinate system 20 is envisaged to be the right-hand coordinate system. Coordinate systems Σ1 to Σ8 shown in FIG. 9 (which will be described later) are also envisaged to be the right-hand coordinate systems.

In one example, the robot system 1 includes the robot 10, an end effector 20 detachable from or attachable to the robot 10, and a robot controller 30 that controls operation of the robot 10 and the end effector 20. The robot 10 is an example of an “articulated robot”, and the robot controller 30 is an example of a “controller.”

In one example, the robot 10 and the robot controller 30 are communicably connected with each other by wire. Wireless connection, or both wired and wireless connection may be applied to connection between the robot 10 and the robot controller 30. The robot controller 30 is communicable with the end effector 20 attached to the robot 10. The robot controller 30 may be an information processing apparatus communicable with other apparatus.

In one example, the robot 10 is an articulated robot used in a farm, a factory, a warehouse, or other similar places. Specifically, the robot 10 is an eight-axis articulated robot that includes six joint mechanisms JEr (JEr1, JEr2, JEr3, JEr4, JEr5, and JEr6) of a six-axis articulated robot, and two additional joint mechanisms JEp (JEp1 and JEp2). The joint mechanisms are rotary joints, and the additional joint mechanisms JEp are prismatic joints. In one example, the robot 10 includes six joint mechanisms JEr, and two joint mechanisms JEp, a base body BDP, two links LK (LK1 and LK2), and an end section TP1. In the example of FIG. 1, the joint mechanism JEr1 is included in the base body BDP, and the joint mechanisms JEr5 and JEr6 are included in the end section TP1. The joint mechanism JEp1 is provided in the link LK1, and the joint mechanism JEp2 is provided in the link LK2. Hereinafter, the joint mechanisms JEr and JEp are not particularly distingished from each other, and they may also be called joint mechanisms JE.

The robot 10 further includes multiple motors for driving the respective joint mechanisms JE. In FIG. 1, some elements, such as the motors for the respective joint mechanisms JE, and a reducer and encoder of each motor, are not illustrated for clarity of illustration. The joint mechanisms JE are examples of “joints.”

The base body BDP is an example of a “base.” The link LK1 is an example of a “first link,” and the link LK2 is an example of a “second link.” In one example, the base body BDP and the end section TP1 are connected through the links LK1 and LK2.

Examples of the connection between members include direct connection between two members and indirect connection between two members. For the direct connection, the two members may be in contact with each other, or they may be substantially in contact with each other. For the latter case, one of the two members may be fixed to the other with adhesive or the like. For the indirect connection, an extra member may be disposed between the two members.

The joint mechanism JEr1 is an example of a “first driving mechanism,” and the joint mechanism JEr2 is an example of a “second driving mechanism.” The joint mechanism JEr3 is an example of a “third driving mechanism,” and the joint mechanism JEr4 is an example of a “fourth driving mechanism.” The joint mechanism JEr5 is an example of a “fifth driving mechanism,” and the joint mechanism JEr6 is an example of a “sixth driving mechanism.” The joint mechanism JEp1 is an example of a “first moving mechanism,” and the joint mechanism JEp2 is an example of a “second moving mechanism.”

In one example, the base body BDP includes a base part BDPba fixed to a predetermined place (e.g., floor) and the joint mechanism JEr1 connected to the joint mechanism JEr2. The joint mechanism JEr1 rotates a portion of the base body BDP about an axis Ax1 perpendicular to a bottom surface BDPbt of the base body BDP. In one example, the joint mechanism JEr1 includes a portion connected to the joint mechanism JEr2, and this portion is a part of an outer wall of the joint mechanism JEr1. For example, the joint mechanism JEr1 rotates the outer wall of the joint mechanism JEr1 relative to the base part BDPba about the axis Ax1 as a rotation axis. In other words, the joint mechanism JEr1 rotates the joint mechanism JEr2 relative to the base body BDP about the axis Ax1 as a rotation axis. The axis Ax1 is an example of a “first rotation axis.”

The term “perpendicular” includes not only “exactly perpendicular” but also “substantially perpendicular” (e.g., perpendicular within an error range). Similarly, the term “parallel” described later includes not only “exactly parallel” but also “substantially parallel” (e.g., parallel within an error range). A rotational direction Dr1 shown in FIG. 1 indicates a rotational direction of the portion of the base body BDP when the portion of the base body BDP rotates about the axis Ax1.

The joint mechanism JEr2 connects the base body BDP and the link LK1 to each other. The joint mechanism JEr2 rotates the link LK1 relative to the base body BDP about an axis Ax2 as a rotation axis. The axis Ax2 is parallel to the bottom surface BDPbt of the base body BDP. The rotational direction Dr2 shown in FIG. 1 indicates a rotational direction of the link LK1 when the link LK1 rotates about the axis Ax2 as the rotation axis. The axis Ax2 is an example of a “second rotation axis.”

In one example, the link LK1 is hollow and is elongated. The link LK1 has an opening Hlk1 extending in a direction De1 of extension of the link LK1. The direction De1 refers to a “direction of extension of the first link.”

In one example, the link LK1 has a surface facing the link LK2. The opening Hlk1 is at a part of the surface of the link LK1. The link LK1 is inside therein with the join mechanism JEp1 and a portion of the join mechanism JEr3. In one example, the portion of the joint mechanism JEr3 is within the link LK1, and the rest of the joint mechanism JEr3 protrudes from the opening Hlk1 to the outside of the link LK1. The joint mechanism JEr3 includes an outer portion protruding outside the link LK1. The outer portion or a portion of the outer portion is inside the link LK2 via an opening Hlk2 (which will be described later) of the link LK2.

The link LK1 rotates relative to the base body BDP about the axis Ax1 as a rotation axis by the joint mechanism JEr1. Additionally, the link LK1 rotates relative to the base body BDP about the axis Ax2 as a rotation axis by the joint mechanism JEr2.

The join mechanism JEr3 connects the link LK1 and the link LK2 to each other. The join mechanism JEr3 rotates the link LK2 relative to the link LK1 about an axis Ax3 as a rotational axis. The axis Ax3 is perpendicular to the direction De1 of extension of the link LK1. The rotational direction Dr3 shown in FIG. 1 indicates a rotational direction of the link LK2 when the link LK2 rotates about the axis Ax3 as the rotation axis. The axis Ax3 is an example of a “third rotation axis.”

The join mechanism JEp1 moves the joint mechanism JEr3 relative to the link LK1 along the direction De1. The movement of the joint mechanism JEr3 along the direction De1 causes the link LK2 to move relative to the link LK1 along the direction De1. A range of motion for the joint mechanism JEr3 moved by the joint mechanism JEp1 is as follows: A substantial length (control length) of the link LK1 is equal to or less than half of the length of the link LK1. Alternatively, the substantial length may be equal to or greater than half of the length of the link LK1.

In one example, the link LK2 is hollow and is elongated. The link LK2 has an opening Hlk2 extending in a directional De2 of extension of the link LK2. The direction De2 refers to as a “direction of extension of the second link.”

In one example, the link LK2 has a surface facing the link LK1. The opening Hlk2 is on a part of the surface of the link LK2. The link LK2 is inside with the joint mechanism JEp2 and a portion of the joint mechanism JEr3. In one example, the portion of the joint mechanism JEr3 is within the link LK1, and the rest of the joint mechanism JEr3 protrudes from the opening Hlk2 to the outside of the link LK2.

The joint mechanism JEp2 moves the link LK2 relative to the joint mechanism JEr3 along the direction De2 of extension of the link LK2. Such a movement causes the link LK2 to move relative to the joint mechanism JEr3 along the direction De2. In other words, the link LK2 moves relative to the link LK1 along the direction De2. A range of motion for the joint mechanism JEr3 moved by the joint mechanism JEp2 is as follows: A substantial length (control length) of the link LK2 is equal to or less than half of the length of the link LK2. Alternatively, the substantial length may be equal to or greater than half of the length of the link LK2.

Thus, the link LK2 is movable relative to the link LK1 along the direction De1 and is movable relative to the link LK1 along the direction De2.

The joint mechanism JEr4 connects the link LK2 and the end section TP1 to each other. The joint mechanism JEr4 rotates the end section TP1 relative to the link LK2 about an axis Ax4 as a rotation axis. The axis Ax4 is perpendicular to the direction De2. A rotational direction Dr4 shown in FIG. 1 indicates a rotational direction of the end section TP1 when the end section TP1 rotates about the axis Ax4 as a rotation axis. The axis Ax4 is an example of a “fourth rotation axis.”

In one example, the end effector 20 for holding an object (product) is attached to the end section TP1. In one example, the end effector 20 is attached to an end surface TP1sf of the end section TP1. The end section TP1 includes a first portion TP11 connected to the link LK2, a second portion TP12 connected to the first portion TP11, the joint mechanism JEr5, and the joint mechanism JEr6. In one example, the first portion TP11 is connected to the link LK2 via the joint mechanism JEr4, and thereby, the first portion TP11 rotates relative to the link LK2 about the axis Ax4 as a rotation axis.

The joint mechanism JEr5 connects the first portion TP11 and the second portion TP12 to each other. The joint mechanism JEr5 rotates the second portion TP12 relative to the first portion TP11 about an axis Ax5 as a rotation axis. The axis Ax5 is perpendicular to the axis Ax4. A rotational direction Dr5 shown in FIG. 1 indicates a rotational direction of the second portion TP12 when the second portion TP12 rotates about the axis Ax5. The axis Ax5 is an example of a “fifth rotation axis.”

The joint mechanism JEr6 rotates at least a portion of the end section TP1 about an axis Ax6 as a rotation axis. The axis Ax6 is perpendicular to the axis Ax5. In the example of FIG. 1, the joint mechanism JEr6 rotates an end surface TP1sf of the end section TP1 about the axis Ax6 as a rotation axis. In other words, the joint mechanism JEr6 rotates a portion (end surface TP1sf) of the end section TP1, to which the end effector 20 is attached, about the axis Ax6 as a rotation axis. A rotational direction Dr6 shown in FIG. 1 indicates a rotational direction of the end surface TP1sf when the end surface TP1sf rotates about the axis Ax6. The axis Ax6 is an example of a “sixth rotation axis.”

In the example of FIG. 1, the surface of the joint mechanism JEr6 corresponds to the end surface TP1sf. If the joint mechanism JEr6 includes the second portion TP12, the end surface TP1sf may be an end surface of the second portion TP12.

Work with the end effector 20 is not limited to holding objects. The end effector 20 may include an appropriate unit (e.g., a robot hand and a robot finger) in accordance with the task to be performed by the robot 10. The end effector 20 suitable for a variety of types of tasks is attached to the end section TP1.

In this embodiment, there are two types of rotations. One of the two is rotation about an axis that forms an angle greater than a predetermined angle with a specific direction. The other of the two is rotation about an axis that forms an angle equal to or less than the predetermined angle with the specific direction. The former angle may be described as “turning” to distinguish from the latter angle. The predetermined angle may be 45°; however, this is not limited to 45°.

For rotation about the axis Ax1 and rotation about the axis Ax2, a direction Dv1 perpendicular to the bottom surface BDPbt of the base body BDP corresponds to the specific direction. The axis Ax1 corresponds to the axis that forms an angle equal to or less than the predetermined angle with the direction Dv1 perpendicular to the bottom surface BDPbt of the base body BDP. The axis Ax2 corresponds to the axis that forms an angle greater than the predetermined angle with the direction Dv1. Thus, rotation of the link LK1 about the axis Ax2 corresponds to “turning.” In this embodiment, a direction Deb of extension of the base body BDP may be the specific direction because the base body BDP extends along the direction Dv1 perpendicular to the bottom surface BDPbt.

For rotation about the axis Ax3, the direction De1 of extension of the link LK1 corresponds to the specific direction. For rotation about the axis Ax4, the direction De2 of extension of the link LK2 corresponds to the specific direction. The axis Ax3 corresponds to an axis that forms an angle greater than the predetermined angle with the direction De1 of extension of the link LK1. The axis Ax4 corresponds to the axis that forms an angle greater than the predetermined angle with the direction De2 of extension of the link LK2. The following two, rotation of the link LK2 about the axis Ax3 as the rotation axis, and rotation of the first portion TP11 about the axis Ax4 as the rotation axis, correspond to the rotation.

For rotation about the axis Ax5, a direction De11 corresponds to the specific direction. For rotation about the axis Ax6, a direction De12 corresponds to the specific direction. The first portion TP11 has two ends: a predetermined end to which the joint mechanism JEr5 is connected, and an end opposite to the predetermined end. The direction De11 refers to a direction from the opposite end to the predetermined end. The direction De11 may be considered as the direction of extension of the first portion TP11. The second portion TP12 has two ends: a predetermined end (the end including the end surface TP1sf) to which the joint mechanism JEr6 is connected, and an end opposite to the predetermined end. The direction De12 refers to a direction from the opposite end to the predetermined end. The direction De12 may be considered as the direction of extension of the second portion TP12.

When the direction De11 is the specific direction, the axis Ax5 corresponds to an axis that forms an angle equal to or less than the predetermined angle with the direction De1l. When the direction De12 is the specific direction, the axis Ax6 corresponds to an axis that forms an angle equal to or less than the predetermined angle with the direction De12. In this embodiment, it is envisaged that the direction De11 is perpendicular to the axis Ax4, and the direction De12 is perpendicular to the axis Ax5. The axis Ax5, which forms an angle equal to or less than the predetermined angle with the direction De11, corresponds to the axis that forms an angle greater than the predetermined angle with the axis Ax4. The axis Ax6, which forms an angle equal to or less than the predetermined angle with the direction De12, corresponds to the axis that forms an angle greater than the predetermined angle with the axis Ax5.

Therefore, in this embodiment, each portion of the robot 10 (the base body BDP, the link LK1, the link LK2, the end section TP1, and the like) rotates about a corresponding axis Ax1, Ax2, Ax3, Ax4, Ax5, and Ax6, as a rotational axis. Such rotations allow the robot 10 to perform substantially the same actions as those of humans.

In one example, the link LK1 between the joint mechanism JEr2 and the joint mechanism JEr3 corresponds to the upper arm. The link LK2 between the joint mechanism JEr3 and the joint mechanism JEr4 corresponds to the forearm. The joint mechanism JEr1 enables the robot 10 to imitate a human twisting at the waist, and the joint mechanism JEr2 enables it to imitate turning at a shoulder. Furthermore, the joint mechanism JEr3 enables the robot 10 to imitate turning at an elbow, and the joint mechanism JEr4 enables it to imitate turning at a wrist. The joint mechanism JEr5 enables the robot 10 to imitate wrist twisting, and the joint mechanism JEr6 enables it to imitate twisting of a fingertip.

In this embodiment, the joint mechanism JEp1 provided in the link LK1 enables the link LK2 to move relative to the link LK1 along the direction De1 of extension of the link LK1. In addition, the joint mechanism JEp2 provided in the link LK2 enables the link LK2 to move relative to the link LK1 along the direction De2 of extension of the link LK2. As a result, in this embodiment, the joint mechanisms JEp1 and JEp2 enable the end section TP1 of the robot 10 to move to the vicinity of the base body BDP. The joint mechanisms JEp1 and JEp2 enlarge a reachable range for the end section TP1 (in more detail, the end surface TP1sf), which enlarges a reachable range for the end effector 20 attached to the robot 10 as well.

The configuration of the robot system 1 is not limited to the example shown in FIG. 1. The robot controller 30 may be built in the robot 10. Although an example is given in which the robot 10 is fixed to a predetermined place (e.g., floor) shown in FIG. 1, the robot 10 is not necessarily fixed to a predetermined place and may be movable. The base part BDPba of the base body BDP may be fixed to the predetermined place (e.g., floor) via the joint mechanism JEr1. In this case, the base body BDP may not include the joint mechanism JEr1. The base part BDPba may be fixed to the predetermined place via the joint mechanism JEr1. In this configuration, the joint mechanism JEr1 may rotate the base part BDPba about the axis Ax1 as a rotation axis. Alternatively, in this configuration, the base part BDPba may be connected to the joint mechanism JEr2.

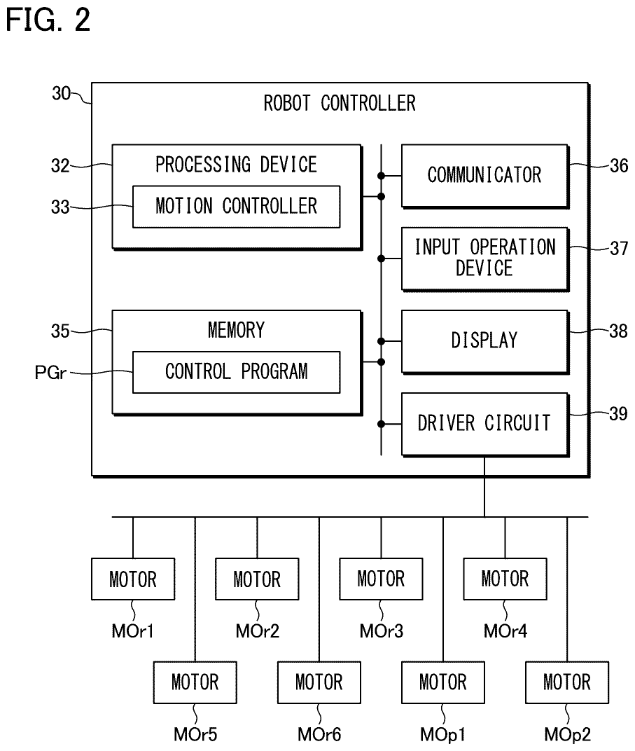

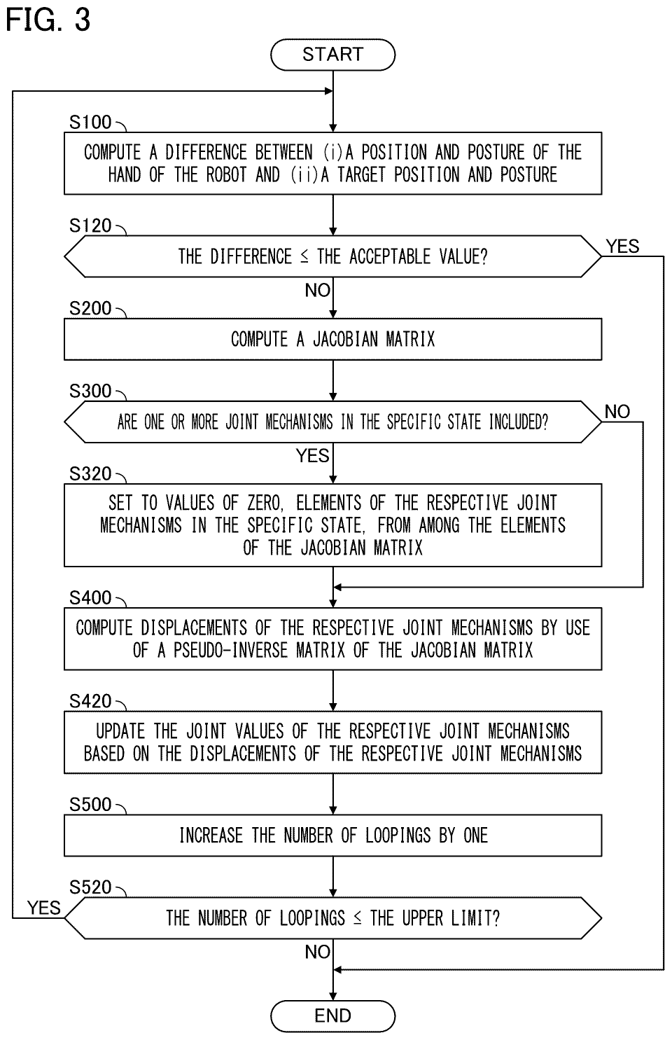

Brief description will now be given of operation of the robot controller 30. Description of a configuration of the robot controller 30 will be given later with reference to FIG. 2. Description of flows of operation of the robot controller 30 will be given later with reference to FIG. 3.

In one example, in order to set a position and posture of the robot 10 to a target position and posture, the robot controller 30 computes a joint value of each joint mechanism JE, in which each joint value is related to a state of the corresponding joint mechanism JE (a state of the joint). The phrase “the state of the joint mechanism JE” may indicate a motion of the joint. Specific examples of the state of the joint mechanism JE include a position of the joint mechanism JE (a position of the joint), and a rotation angle of the joint mechanism JEr (an orientation of the joint). In this case, the joint value indicates a position of the joint mechanism JE (a position of the joint) and a rotation angle of the joint mechanism JEr (an orientation of the joint). The phrase “the joint value related to a state of the corresponding joint mechanism JE (a state of the joint)” is simply referred to as “a joint value of the joint mechanism JE (the joint).

In one example, a relationship between a velocity of the hand of the robot 10 (e.g., the distal end of the end effector 20) and a joint velocity is defined by Formula (1). Hereinafter, the velocity of the hand of the robot 10 is referred to as a “hand velocity.”

Formula (1) is as follows:

$$\dot{r} = J \dot{θ} \qquad ( 1 )$$

Where, \dot{r} represents a hand velocity (vector) and is also denoted as r (·); \dot{θ} represents joint velocity (vector) and is also denoted as θ(·); and J represents a Jacobian matrix showing a relationship between the hand velocity and the joint velocity.

The hand velocity r (·) is defined by Formula (2). In an articulated robot with m joints (m is a natural number of 2 or more), the joint velocity θ (·) is defined by Formula (3), and the Jacobian matrix J is defined by Formula (4).

Formula (2) is as follows:

$$\dot{r} = [ \begin{matrix}\dot{p} \\ ω\end{matrix} ] \qquad ( 2 )$$

Where, \dot{p} represents a translational velocity vector of the hand and is also denoted as p (·); and @ represents an angular velocity vector.

Formula (3) is as follows:

$$\dot{θ} = [ \begin{matrix}{\dot{θ}}_{1} \\ ⋮ \\ {\dot{θ}}_{i} \\ ⋮ \\ {\dot{θ}}_{m}\end{matrix} ] \qquad ( 3 )$$

Where, \dot{θ}represents a i-th joint velocity.

Formula (4) is as follows:

$$J = [ \begin{matrix}{J}_{1} & … & {J}_{i} & … & {J}_{m}\end{matrix} ] \qquad ( 4 )$$

Where, Ji represents an element of the i-th joint.

In one example, the Jacobian matrix J is denoted by a matrix of six rows and m columns, and an element of the i-th column indicates an element J1 associated with the i-th joint. When the i-th joint is a rotary joint, an element J1 associated with the i-th joint is defined by Formula (5). When the i-th joint is a prismatic joint, the element J1 is defined by Formula (6). The value of “0” in Formula (6) indicates that a vector value is zero.

Formulas (5) and (6) are as follows:

$${J}_{i} = [ \begin{matrix}{}^{0} {z}_{i} \times {}^{0} {p}_{ei} \\ {}^{0} {z}_{i}\end{matrix} ] \qquad ( 5 )$$

$${J}_{i} = [ \begin{matrix}{}^{0} {z}_{i} \\ 0\end{matrix} ] \qquad ( 6 )$$

Where ⁰zᵢ represents a unit vector in the positive direction of the Zi axis, as seen from the reference coordinate system Σ0.

When the i-th joint is a rotary joint, the Z axis corresponds to a rotation axis of the joint mechanism JEr. When the i-th joint is a prismatic joint, the Z axis corresponds to an axis of movement of the joint mechanism JEp or an axis of extension and retraction of the link LK.

A relationship between the hand velocity and the joint velocity of the robot 10 is defined by Formula (7), using a pseudo-inverse matrix J⁺ of the Jacobian matrix J.

Formula (7) is as follows:

$$\dot{θ} = {J}^{+} \dot{r} \qquad ( 7 )$$

In one example, the robot controller 30 computes a joint velocity θi(·) of each joint mechanism JE for a target hand velocity r (·) from Formula (7) and operates to move the joint mechanisms JE based on the result of the computation. Specifically, based on the joint velocity θi(·) of each joint mechanism JE from Formula (7), the robot controller 30 computes a joint value of each joint mechanism JE. The robot controller 30 then operates to move the joint mechanisms JE based on the computed joint values of the respective joint mechanisms JE.

In this embodiment, motion of the robot 10 is operated by jog motion. In the jog motion, a position and posture of the robot reach the target position and posture by moving the joints and the hand little by little. Each joint value is information on the joint velocity θi(·) and a state of each joint mechanism JE computed based on the joint velocity θi(·). An example of computation of inverse kinematics include computation of the joint velocity θ (•) of each joint mechanism JE. Given that the pseudo-inverse matrix J⁺is computed from the Jacobian matrix J, computation of the joint velocity θ (•) of each joint mechanism JE from Formula (7) indicates computation of inverse kinematics with the Jacobian matrix.

In the jog motion, the joint velocity θi(·) is computed for all of the joint mechanisms JE. Use of a normal control method with the Jacobian matrix J (hereinafter, a comparative control method) may cause one or more joint mechanisms JE computed based on the joint velocity θi(·) to exceed a range of motion for the joint mechanism JE. In such a case, the robot is unable to follow a determined jog motion. Additionally, for an articulated robot with eight or more joints, if joints to be operated are limited to be less than the total number of joints (e.g., joints to be operated are limited to six or seven joints), the comparative control method fails to operate such a robot.

Based on the fact, in this embodiment, if joints of the robot 10 to be operated are limited to be less than the total number of joints, the element J1 for a specific i-th joint, from among the multiple elements of the Jacobian matrix J, is fixed to a vector value of zero. The Jacobian matrix J with the element J1 for the i-th joint set to the vector value of zero is defined by Formula (8). Here, the joint velocity θi (·) from the Formula (7) represents a joint velocity vector defined by Formula (9).

Formulas (8) and (9) are as follows:

$$J = [ \begin{matrix}{J}_{1} & … & {J}_{i - 1} & 0 & {J}_{i + 1} & … & {J}_{m}\end{matrix} ] \qquad ( 8 )$$

$$\dot{θ} = [ \begin{matrix}{\dot{θ}}_{1} \\ ⋮ \\ {\dot{θ}}_{i - 1} \\ 0 \\ {\dot{θ}}_{i + 1} \\ ⋮ \\ {\dot{θ}}_{m}\end{matrix} ] \qquad ( 9 )$$

As shown in Formula (9), the joint velocity θi (·) of the i-th joint is zero. Thus, in this embodiment, from among the multiple elements of the Jacobian matrix J, the element J1 for the i-th joint is fixed to a vector value of zero. This fixation keeps the joint value of the i-th joint, and the i-th joint from among the m joints can be regarded as the fixed joint. In other words, the fixation, by which the element J1 for the i-th joint of the Jacobian matrix J is set to a vector value of zero, enables computation of the joint velocity θi (·) for the (m-1) joints other than the i-th joint. As a result, the robot 10 can operate even if joints to be operated are limited to be less than the total number of joints.

In this embodiment, the vector value is fixed to zero. However, as long as the joint value of the i-th joint remains substantially unchanged without affecting control of the robot, the vector value is not necessarily zero and may be a minute value (substantially zero). Here, the phrase “substantially zero” indicates not only zero but also a very small value regarded as zero. The phrase “the joint value remains substantially unchanged” indicates not only “the vector value remains strictly unchanged” but also “the joint value remains seemly unchanged (e.g., a minute change with less effect on control of the robot).

In one example, it is envisaged that a certain joint (i-th joint) from among the multiple joints is in a specific state. If the certain joint receives a constraint about its joint value (e.g., a range of motion), in the specific state according to this disclosure, the joint value is close to the limit of the constraint. Specifically, the certain joint value takes, within the range of motion, a value of the boundary range between the inside and outside the range of motion.

The specific state is determined based on a joint value of the i-th joint. The robot controller 30 deals with the i-th joint in the specific state as a fixed joint with its element (vector value) of the Jacobian matrix J fixed to a value of substantially zero. When a constraint on the displacement is satisfied, such a state is called a “limited state.” As will be described later, the robot controller 30 detects a reach of the joint (the joint mechanism JE) to the limited state before the reaching, by use of play in movement of the joint (a remainder of the range of motion for the joint).

In one example, the constraint on the displacement of the joint relates to motion of the joint mechanism JE, and examples of the constraint include a range of motion for the joint mechanism JEr3 moved by the joint mechanism JEp1, the range of motion for the joint mechanism JEr3 moved by the joint mechanism JEp2.

In one example, when the joint mechanism JEr3 moves by the joint mechanism JEp1 relative to the link LK1, a range of motion for the joint mechanism JEr3 is defined by the length of the link LK1. Specifically, the joint mechanism JEr3 to be moved by the joint mechanism JEp1 has an upper limit and lower limit of the range of motion. The upper limit is located close to one of the two ends of the link LK1, and the lower limit is located close to the other end. When the joint mechanism JEr3 reaches the upper or lower limit of the range of motion, the joint mechanism JEp1, which moves the joint mechanism JEr3, is in the limited state. In one example, when the joint mechanism JEr3 is positioned close to the end of the link LK1, the robot controller 30 identifies that the joint mechanism JEp1 is in the specific state. In the specific state, there remains play in movement of the joint mechanism JEr3 compared to the limited state.

Similarly, when the joint mechanism JEp2 moves the joint mechanism JEr3 relative to the link LK2, the range of motion for the joint mechanism JEr3 is defined by the length of the link LK2. Specifically, the joint mechanism JEr3 to be moved by the joint mechanism JEp2 has an upper limit and lower limit of the range of motion. The upper limit is located close to one of the two ends of the link LK2, and the lower limit is located close to the other end. When the joint mechanism JEr3 reaches the upper or lower limit of the range of motion, the joint mechanism JEp2, which moves the joint mechanism JEr3, is in the limited state. In one example, when the joint mechanism JEr3 is positioned close to of the end of the link LK2, the robot controller 30 identifies that the joint mechanism JEp2 is in the specific state.

In one example, when one or more joint mechanisms JE in the specific state (which is determined based on the corresponding joint value) are included in the multiple joint mechanisms JE, the robot controller 30 fixes to zero, elements for the respective joint mechanisms JE in the specific state, from among the multiple elements of the Jacobian matrix J. In computation of inverse kinematics with the Jacobian matrix, elements for the respective joint mechanisms JE in the specific state are set to values of zero, and the joint values thereof in the specific state are fixed.

In one example, the robot controller 30 repeats unit processing until a position and posture of the robot 10 reach the target position and posture. The unit processing includes (i) computation processing for computing joint values of the respective joint mechanisms JE, and (ii) fixation processing for keeping one or more joint values of the respective joint mechanisms JE in the specific state.

Thus, the unit processing is repeated which includes the computation processing. In this computation processing, the robot controller 30 computes joint values of the respective joint mechanisms JE. In computing these joint values, the robot controller 30 uses computation of inverse kinematics to compute displacements of the respective joint mechanisms JE when the robot 10 operates. Furthermore, the unit processing is repeated which includes the fixation processing. In this fixation processing, when one or more joint mechanisms JE in the specific state are included in the multiple joint mechanisms JE, the robot controller 30 sets joint values of the respective joint mechanisms JE in the specific state to the fixed value.

In the computation processing, when one or more joint mechanisms JE in the specific state are included in the multiple joint mechanisms JE, the robot controller 30 performs computation of inverse kinematics by use of joint mechanisms JE other than the joint mechanisms JE in the specific state.

In this embodiment, the frequency of incorrect results from computation of inverse kinematics is reduced, and each joint mechanism JE is prevented from exceeding the range of motion.

The configuration of the robot 10 is not limited to the example of FIG. 1. The robot 10 may have a configuration of a simulation model shown in FIG. 9 (which will be described later). In the simulation model shown in FIG. 9, the link LK1 is extendable and retractable by the joint mechanism JEp1 of the robot 10 shown in FIG. 1, and the link LK2 is extendable and retractable by the joint mechanism JEp2. The constraint on motion of each joint mechanism JE is not limited to two ranges of motion; a range of motion for the joint mechanism JEr3 moved by the joint mechanism JEp1, and a range of motion for the joint mechanism JEr3 moved by the joint mechanism JEp2. In one example, the constraint on motion of each joint mechanism JE may include avoidance of a singularity that causes loss of control of the posture of the robot 10. Thus, the restriction on motion of each joint mechanism JE may be placed on one, some, or all of the multiple joint mechanisms JE.

Description will now be given of a hardware configuration of the robot controller 30 with reference to FIG. 2.

FIG. 2 shows an example of a hardware configuration of the robot controller 30 shown in FIG. 1.

The robot controller 30 includes a processing device 32 that controls each element of the robot controller 30, a memory 35 that stores a variety of of information, a communicator 36, an input operation device 37 that receives input operations from a human operator, a display 38, and a driver circuit 39.

In one example, the memory 35 includes one or both of the following (i) and (ii): (i) a volatile memory, such as a RAM (Random Access Memory) for a working area of the processing device 32, and (ii) a non-volatile memory, such as an EEPROM (Electrically Erasable Programmable Read-Only Memory) for storing a variety of types of information, such as a control program PGr. The memory 35 may be detachable from and attachable to the robot controller 30. Specific examples of the memory 35 include a storage medium, such as a memory card that is detachable from and attachable to the robot controller 30, and a storage device communicably connected to the robot controller 30 via a network (e.g., an online storage).

The memory 35 shown in FIG. 2 stores the control program PGr. The control program PGr is an example of a “program.” In this embodiment, the control program PGr includes an application program for the robot controller 30 to control operation of the robot 10. However, the control program PGr may include a program for operating the robot system in which the processing device 32 controls each element of the robot controller 30. In this embodiment, it is envisaged that the memory 35 corresponds to a computer-readable non-transitory recording medium on which the control program PGr is recorded.

The processing device 32 is a processor that controls the entire robot controller 30 and comprises one or more CPUs (Central Processing Units). In one example, the processing device 32 executes the control program PGr stored in the memory 35 and operates in accordance with the control program PGr, to act as a motion controller 33. In one example, the motion controller 33 repeats the unit processing described in FIG. 1 until a position and posture of the robot 10 reach the target position and posture. The motion controller 33 drives the robot 10 via the driver circuit 39 (which will be described later) based on the joint values of the respective joint mechanisms JE. The control program PGr may be transmitted from another device via the network.

In one example, if the processing device 32 comprises two or more CPUs, one, some, or all the functions of the processing device 32 may be achieved by operation of the CPUs in cooperation with programs including the control program PGr. The processing device 32 may comprise hardware, such as a GPU (Graphics Processing Unit), a DSP (Digital Signal Processor), or a FPGA (Field Programmable Gate Array), in addition to, or in place of one, some, or all of the CPUs. In this case, one, some, or all of the functions of the processing device 32 may be achieved by hardware, such as a DSP.

The communicator 36 is a hardware device that communicates with a device outside the robot controller 30. In one example, the communicator 36 communicates with an external device by short-range wireless communication. The communicator 36 may communicate with an external device via a mobile network or a network.

The input operation device 37 is an input device, such as a keyboard, a mouse, switches, buttons, and sensors. In one example, the input operation device 37 receives input operations from a human operator and outputs information on the input operations to the processing device 32. The input operation device 37 may be a touch panel that detects touch inputs to the screen of the display 38.

The display 38 displays images under control of the processing device 32. The input operation device 37 and the display 38 may be a unitary device, such as a touch pane.

The driver circuit 39 is a hardware device that outputs a signal for driving the robot 10 to the robot 10 under the control of the processing device 32 (specifically, the motion controller 33). In one example, the driver circuit 39 outputs to the robot 10, signals defined based on joint values of the respective joint mechanisms JE. These signals are used to drive respective motors MOr1, MOr2, MOr3, MOr4, MOr5, MOr6, MOp1, and MOp2. These motors MOr1, MOr2, MOr3, MOr4, MOr5 and MOr6 drive the joint mechanisms JEr1, JEr2, JEr3, JEr4, JEr5 and JEr6, respectively. The motors MOp1 and MOp2 drive the joint mechanisms JEp1 and JEp2, respectively. Hereinafter, these motors MOr1, MOr2, MOr3, MOr4, MOr5, MOr6, MOp1 and MOp2 are collectively denoted as a motor MO.

Thus, the robot controller 30 controls operation of the robot 10 by controlling the multiple motors MO.

Description will now be given of an outline of operation of the robot controller 30 with reference to FIG. 3.

FIG. 3 is a flowchart showing an example of operation of the robot controller 30 shown in FIG. 1. In the operation shown in FIG. 3, joint values of the respective joint mechanisms JE (e.g., positions of the joint mechanisms JE and rotation angles of the joint mechanisms JEr) are computed, which sets a position and posture of the hand of the robot 10 to the target position and posture. A sequence of steps S100 to S520 shown in FIG. 3 is performed by the processing device 32 (the motion controller 33).

First, at step S100, the motion controller 33 computes a difference between (i) a position and posture of the hand of the robot 10 and (ii) the target position and posture. Specifically, the motion controller 33 computes a position and posture of the hand of the robot 10 based on the current joint values of the respective joint mechanisms JE. The motion controller 33 then computes a difference between (i) the computed position and posture of the hand of the robot 10 and (ii) the target position and posture.

At step S120, the motion controller 33 then determines whether the computed difference is below an acceptable value. In one example, when the computed difference is below the acceptable value, the acceptable value is defined to be an approximate value of which the position and posture are identical to the target position and posture.

When a result of the determination at step S120 is affirmative, the motion controller 33 ends the operation shown in FIG. 3. In this case, the computed joint values of the respective joint mechanisms JE at step S100 are used as the latest joint values to set a position and posture of the hand of the robot 10 to the target position and posture. When the sequence of steps S100 to S520 is repeated two or more times, the updated joint values obtained at the previous step S420 are used at the current step S100.

In contrast, when the result at step S120 is negative, the motion controller 33 advances the processing to step S200.

At step S200, the motion controller 33 computes a Jacobian matrix J based on the current joint values of the respective joint mechanisms JE. The motion controller 33 then advances the processing to step S300.

At step S300, the motion controller 33 determines whether one or more joint mechanisms JE in the specific state are included in the multiple joint mechanisms JE. When a result of the determination at step S300 is affirmative, the motion controller 33 advances the processing to step S320. In contrast, when the result at step S300 is negative, the motion controller 33 advances the processing to step S400.

At step S320, the motion controller 33 sets to values of substantially zero, elements of the respective joint mechanisms JE in the specific state, from among the multiple elements of the Jacobian matrix J. The motion controller 33 then advances the processing to step S400.

At step S400, the motion controller 33 computes displacements of the respective joint mechanisms JE (e.g., a joint velocity θi(·) of each joint mechanism JE) by use of a pseudo-inverse matrix J⁺ of the Jacobian matrix J. When one or more joint mechanisms JE in the specific state are included in the multiple joint mechanisms JE, displacements of the respective joint mechanisms JE in the specific state are zero or approximately zero. This is because the element of the respective joint mechanisms JE in the specific state, on the column of the Jacobian matrix J, are set to approximately zero (values regarded as zero). After step S400, the motion controller 33 advances the processing to step S420.

At step S420, the motion controller 33 updates the joint values of the respective joint mechanisms JE based on the displacements of the respective joint mechanisms JE. Specifically, to update the joint values of the respective joint mechanisms JE, the motion controller 33 adds the displacements of the respective joint mechanisms JE into the computed joint values of the respective joint mechanisms JE obtained at step S100. When one or more joint mechanisms JE in the specific state are included in the multiple joint mechanisms JE, displacements of the respective found joint mechanisms JE in the specific state are zero or approximately zero. As a result, post-updated joint values of the respective joint mechanisms at step S420 are the same as, or substantially the same as (regarded as), pre-updated values. As a result, the joint mechanisms JE in the specific state are maintained. In this embodiment, each joint mechanism JE is prevented from exceeding the range of motion.

Thereafter, at step S500, the motion controller 33 increments the number of loopings by one. The number of loopings is initialized to zero before the start of the operation shown in FIG. 3.

Thereafter, at step S520, the motion controller 33 determines whether the number of loopings is below an upper limit. The upper limit indicates a limit of the number of repetitions of the sequence of steps S100 to S520. The upper limit is set for termination of the operation shown in FIG. 3 when it fails to converge.

When a result of the determination at step S520 is negative, the motion controller 33 stops the operation shown in FIG. 3. In this case, the updated joint values of the respective joint mechanisms JE at step S420 are used for latest joint values to be computed. However, when the operation shown in FIG. 3 is completed due to the number of loopings exceeding the upper limit, the latest joint values may not cause the position and posture of the hand of the robot 10 to be the target position and posture. Based on the fact, the motion controller 33 may notify the human operator of an error indicative of nonconvergence of computation of the joint values. In one example, the motion controller 33 may display the error on the display 38.

In contrast, when the result of the determination at step S520 is affirmative, the motion controller 33 returns the processing to step S100. Thus, the sequence of steps S100 to S520 is repeated until final joint values of the respective joint mechanisms JE are computed to set a position and posture of the hand of the robot 10 to the target position and posture. Alternatively, the sequence of steps is repeated until the number of loopings exceeds the upper limit.

In one example, the sequence of steps S400 and S420 corresponds to the “computation processing” described in FIG. 1. The sequence of steps S300 and S320 corresponds to the “fixation processing” described in FIG. 1. The sequence of steps S100 to S520 corresponds to the “unit processing including the computation processing and the fixation processing.” The computation processing may include step S200 in addition to steps S400 and S420. The sequence of steps S400 and S420 may be the “computation processing.”

The operation of the robot controller 30 is not limited to the example shown in FIG. 3. In one example, steps S500 and S520 may be omitted. In this case, after step S420, the motion controller 33 returns the processing to step S100. For omission of steps S500 and S520, the operation shown in FIG. 3 may be terminated by an interruption. Steps S300 and S320 may be incorporated into step S200.

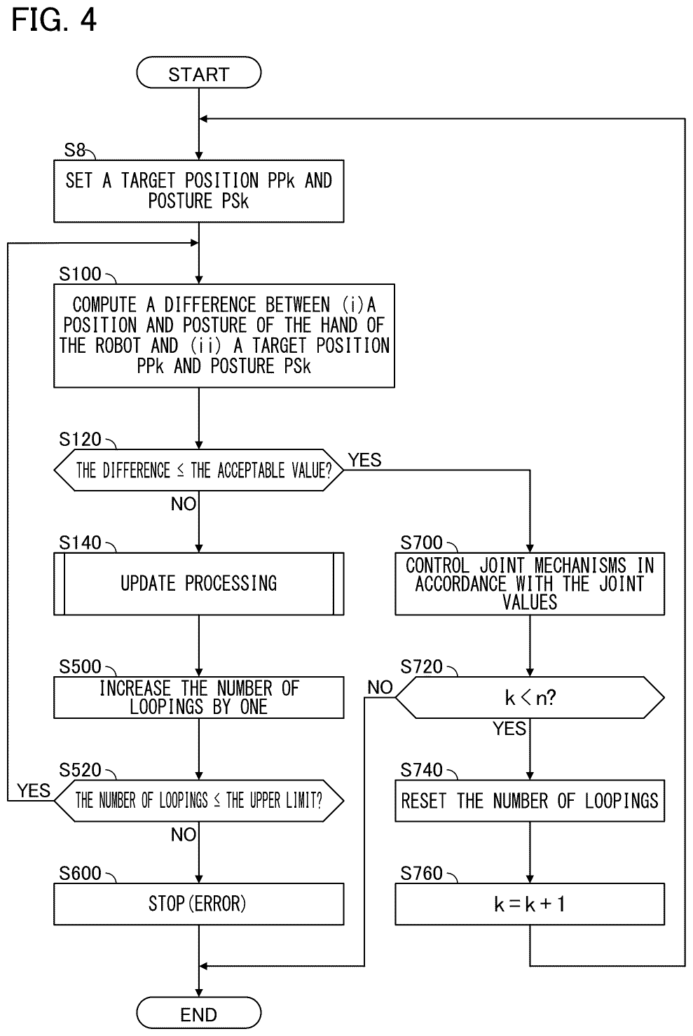

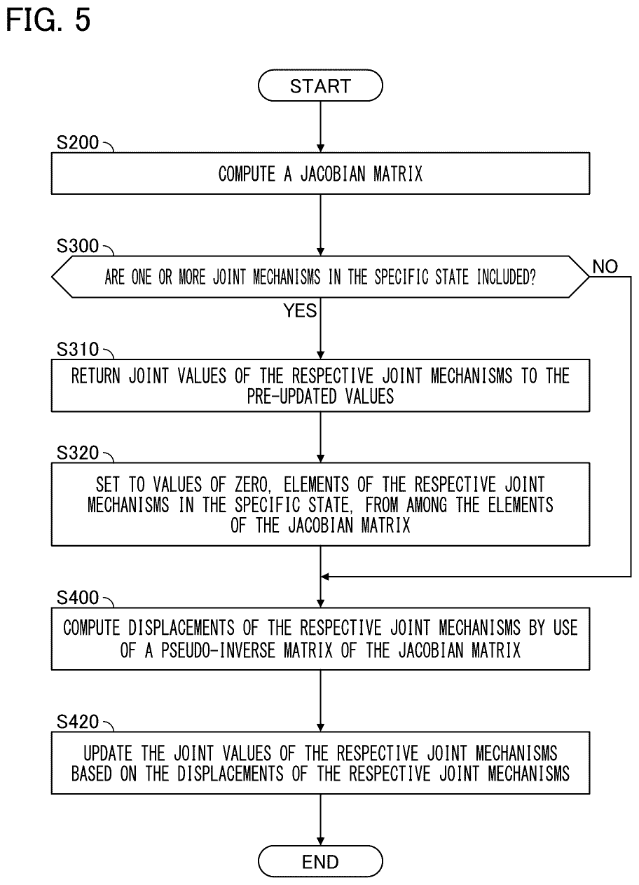

With reference to FIGS. 4 and 5, description will now be given of an outline of the operation of the robot controller 30 by which the robot 10 is changed to a final target state via one or more target states.

FIG. 4 is a flow chart showing an example of operation of the robot controller 30 by which a position and posture of the hand of the robot 10 is sequentially changed to one or more target positions PP and postures PS. In the operation shown in FIG. 4, n target positions PP and postures PS are envisaged, where n is a natural number of two or more. Hereinafter, the n target positions PP and positions PS are denoted as n target states.

In the operation shown in FIG. 4, step S8, step S600, and a sequence of steps S700 to S760 are incorporated into the operation shown in FIG. 3. Furthermore, in update processing, joint values are updated at step S1Δθ as a sequence of steps S200 to S420 shown in FIG. 3. Detailed description of the update processing at step S1Δθ will be described later with reference to FIG. 5. In one example, the update processing at step S1Δθ is similar to the sequence of steps S200 to S420 shown in FIG. 3. However, step S310 shown in FIG. 5 is performed when one or more joint mechanisms JE in the specific state are included in the multiple joint mechanisms JE. The joint values of the respective joint mechanisms JE are updated by the update processing at step S140.

In this embodiment, it is envisaged that as an initial state of the robot 10 prior to start of the operation shown in FIG. 4, no joint mechanism JE in the specific state is included in the multiple joint mechanisms JE. In the operation shown in FIG. 4, it is also envisaged that an initial variable k is one, where k is a natural number of one or more and n or less. Hereinafter, k-th target position PP is denoted as “position PPk,” and k-th posture PS is denoted as “posture PSk.” In one example, a position PP1 represents a first target position PP, and a posture PS1 represents a first target posture PS. A position PPn represents the n-th target position (final target position), and a position PSn represents the n-th position PP (final target posture).

In the operation shown in FIG. 4, n target positions PP and n postures PS, which represent a trajectory of the robot 10 from the initial state to the final target state, are defined in the robot controller 30. Specifically, the robot controller 30 updates a target position PPk and posture PSk of the hand of the robot 10 by changing the variable k in order from one to n.

First, at step S8, the motion controller 33 sets k-th target position PPk and posture PSk of the hand of the robot 10. In one example, upon start of the operation shown in FIG. 4, the motion controller 33 sets a first position PP1 and posture PS1 of a first target (k=1) at step S8. After step S8, the motion controller 33 advances the processing to step S100.

A sequence of steps S100 and S120 is identical to that shown in FIG. 3. However, when a result of the determination at step S120 is affirmative, the motion controller 33 advances the processing to step S700. In contrast, when the result at step S120 is negative, the motion controller 33 performs the update processing at step S1Δθ and then advances the processing to step S500.

A sequence of steps S500 and S520 is identical to that shown in FIG. 3. In the operation shown in FIG. 4, when a result of the determination at step S520 is negative, the motion controller 33 stops operating the robot 10 due to an error at step S600. In this case, the operation shown in FIG. 4 is ended. In contrast, when the result at step S520 is affirmative, the motion controller 33 returns the processing to step S100 in a manner similar to the operation shown in FIG. 3.

As described above, when a result of the determination at step S120 is affirmative, step S700 is performed.

At step S700, the motion controller 33 controls the joint mechanisms JE in accordance with the updated joint values. As a result, the hand of the robot 10 reaches the target position PPk and posture PSk. If a human operator teaches the robot 10 an operation, the motion controller 33, at step S700, may store the updated joint values in the memory 35.

Description will be given in which a difference between (i) an initial position and posture of the robot 10 in the initial state and (ii) the target position and posture is below the acceptable value. In this case, the result at step S120 indicates affirmative, and the update processing at step S1Δθ is not performed once. Thus, the motion controller 33 controls the joint mechanisms JE in accordance with the initial joint values in the initial state. In one example, when the result at step S120 is affirmative, and when the update processing is not performed at step S1Δθ once, the motion controller 33 keeps the initial joint values at step S700.

After step S700, the motion controller 33 advances the processing to step S720.

At step S720, the motion controller 33 determines whether the variable k is less than n. When a result of the determination at step S720 is negative, that is, when the position and posture of the hand of the robot 10 change to the final target position PPn and posture PSn, the motion controller 33 stops the operation shown in FIG. 3. In contrast, when the result at step S720 is affirmative, the motion controller 33 resets the number of loopings to zero at step S740 and then advances the processing to step S760.

At step S760, the motion controller 33 increments the variable k by one (k=k+1). The motion controller 33 then returns the processing to step S8. At step S8, next target position PPk and posture PSk of the hand of the robot 10 are set.

Thus, in the operation shown in FIG. 4, for each of the n target states (positions PP and postures PS), a sequence of steps S100 to S520 (i.e., unit processing) is repeated until the difference is below the acceptable value. Here, the difference is between (i) the position and posture of the hand of the robot 10 and (ii) the target position PPk and posture PSk.

With reference to FIG. 5, description will now be given of the update processing at step S140.

FIG. 5 is a flowchart showing an example of the update processing shown in FIG. 4. In one example, in the update processing at step S1Δθ shown in FIG. 4, the processing device 32 that acts as the motion controller 33 performs a sequence of steps S200 to S420 shown in FIG. 5. Step S200 is performed when a result of the determination at step S120 shown in FIG. 4 is negative. After step S420, step S500 shown in FIG. 4 is performed.

Hereinafter, a phrase “k-th target state” is introduced. For example, an expression “processing performed when the target position PP and posture PS are k-th target position PPk and posture PSK” is rephrased as “processing in the k-th target state.” Unless otherwise specified, the update processing indicates update processing in the kth target state.

A sequence of steps S200 and S300 is identical to that shown in FIG. 3. However, in the operation shown in FIG. 5, when a result of the determination at step S300 is affirmative, the motion controller 33 advances the processing to step S310. In contrast, when the result at step S300 is negative, the motion controller 33 advances the processing to step S400 in a manner similar to the operation shown at FIG. 3.

At step S310, the motion controller 33 returns the joint values of the respective joint mechanisms JE to the pre-updated values. In other words, the motion controller 33 cancels update of these joint values obtained at the previous step S420 (by the previous update processing). Specifically, the motion controller 33 returns the joint values of the respective joint mechanisms JE to pre-updated joint values that have not been updated at the previous step S420 (by the previous update processing). In other words, the motion controller 33 returns “first joint values” updated at the previous step S420 to “second joint values” indicative of the pre-updated joint values.

Here, description will be given of a first-time update processing after the position PP and posture PK are updated to the target position PPk and posture PSk. When a result of the determination at step S300 is affirmative, the previous update processing indicates the last update processing in the (k−1)-th target state. At step S310, the motion controller 33 returns the joint values of the respective joint mechanisms JE to joint values obtained before the joint values have been updated by the last update processing (the last step S420) in the (k−1)-th target state.

After step S310, the motion controller 33 advances the processing to step S320, which is identical to that shown in FIG. 3. In the example of FIG. 5, the Jacobian matrix J used at step S320 is computed at step S200 before step S310. However, the Jacobian matrix J used at step S320 may be computed based on the joint values of the respective joint mechanisms JE obtained after step S310 (e.g., a Jacobian matrix J computed at the previous update processing at step S200).

One or more joint mechanisms JE in the specific state to be subjected to the fixation processing at step S320 are identified at step S300 that comes before step S310 (cancellation of update of the joint values of the respective joint mechanisms JE). In other words, one or more joint mechanisms JE in the specific state to be subjected to the processing at step S320 are identified based on the joint values (“first joint values”) obtained before the cancellation of update of the joint values of the respective joint mechanisms JE.

After step S320, the motion controller 33 advances the processing to step S400. A sequence of steps S400 and S420 (the computation processing) is identical to that shown in FIG. 3. When one or more joint mechanisms JE in the specific state are included in the multiple joint mechanisms JE, step S310 is performed in the update processing shown in FIG. 5. Therefore, the update processing at step S420 is performed on two or more joint values of the respective joint mechanisms JE in a non-specific state (a state that is not the specific state).

Thus, when one or more joint mechanisms JE in the specific state are included in the multiple joint mechanisms JE, in the update processing shown in FIG. 5, update of the joint values of the respective joint mechanisms JE at the previous step S420 (by the previous update processing) is cancelled at the current step S320 (the current update processing). In other words, the update of the joint values of the respective joint mechanisms JE computed at the previous sequence of steps S400 and S420 (the previous computation processing) is canceled.

As described above, one or more joint mechanisms JE in the specific state to be subjected to the fixation processing at step S320 are identified based on the joint values obtained before the cancellation of the update. When one or more joint mechanisms JE in the specific state are included in the multiple joint mechanisms JE, steps S310 (the cancellation) and S320 (the fixation processing) are performed, and then steps S400 and S420 are performed.

As shown in FIG. 5, the update processing at step S420 in the update processing is performed on two or more joint values of the respective joint mechanisms JE in the non-specific state. With the joint mechanisms JE in the specific state being fixed, repetition of a sequence of steps S100 to S520 (the unit processing) is prevented in the operation shown in FIGS. 4 and 5.

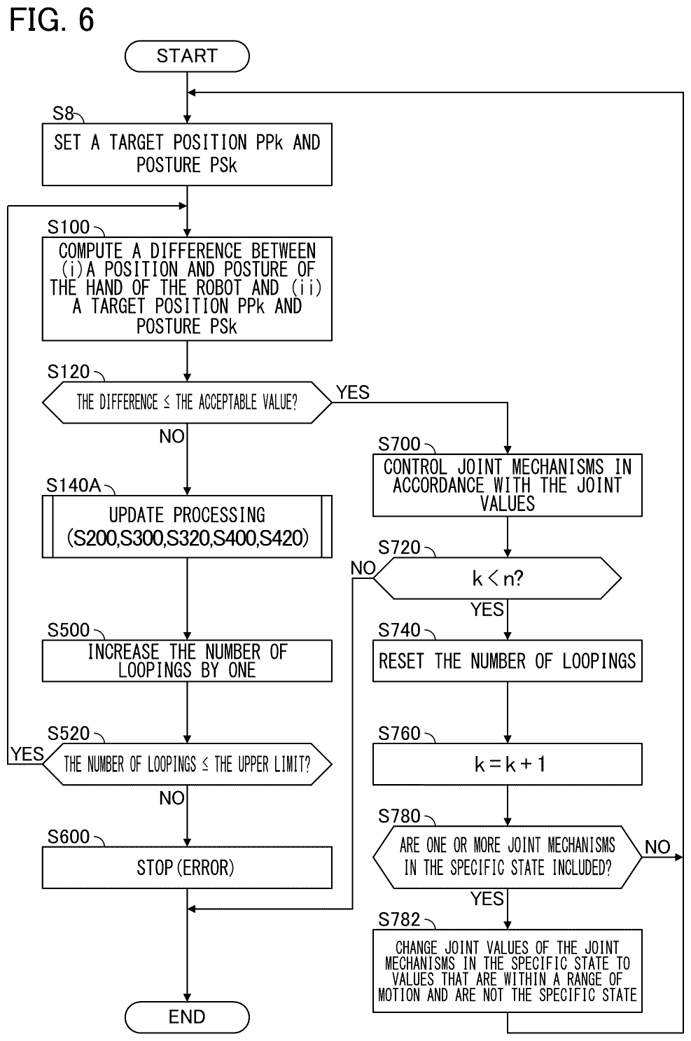

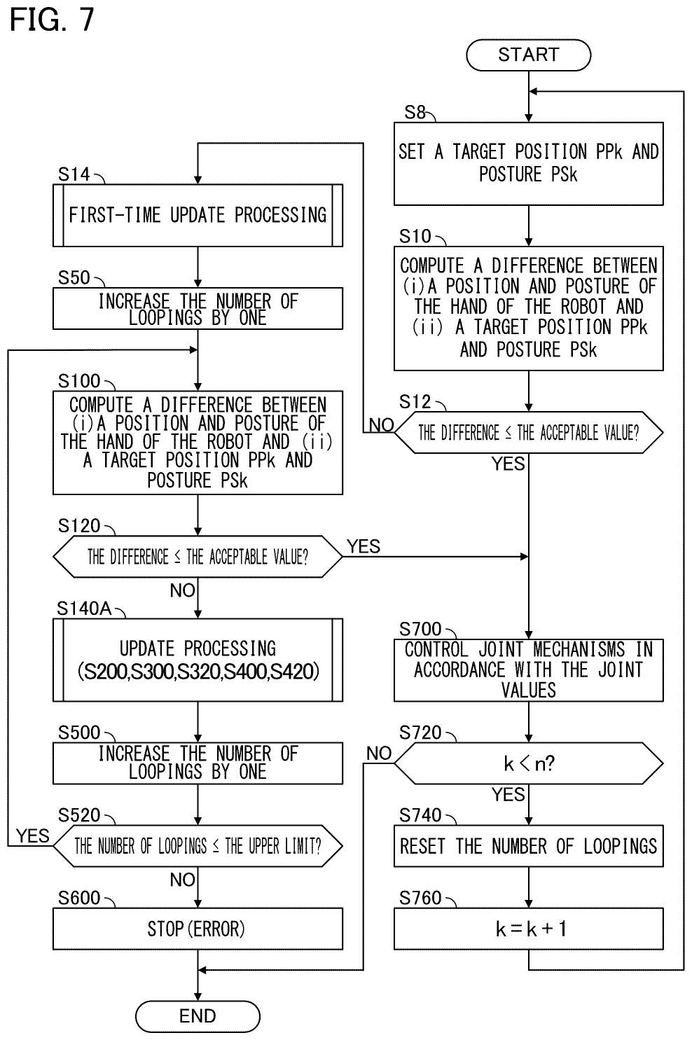

The operation of the robot controller 30, specifically, operation performed when positions and postures of the hand of the robot 10 are sequentially changed to target positions PP and postures PS, is not limited to examples of FIGS. 4 and 5. In one example, step S7Δθ may be after step S760, or it may be in conjunction with step S760. The aforementioned operation of the robot controller 30 may be an operation shown in FIG. 6 or FIG. 7.

FIG. 6 is a flow chart showing another example of operation of the robot controller 30 when positions and postures of the hand of the robot 10 are sequentially changed to target positions PP and postures PS. The operation shown in FIG. 6 is similar to that shown in FIG. 4. However, update processing at step S140A is performed instead of the update processing at step S1Δθ shown in FIG. 4, and a sequence of steps S780 and S782 is incorporated into the operation shown in FIG. 4.

The update processing at step S140A is comprised of a sequence of steps S200 to S420 shown in FIG. 3. A sequence of steps S100 to S520 shown in FIG. 6 is similar to that shown in FIG. 3. The sequence of steps S100 to S520 shown in FIG. 6 involves no step S310 shown in FIG. 5 (cancellation of update of the joint values of the respective joint mechanisms JE). The operation shown in FIG. 6 involves steps S780 and S782 after step S760. However, step S310 shown in FIG. 5 is not performed in the update processing at step S140A. Main description will be given below of steps S780 and S782.

After step S760, the motion controller 33 advances the processing to step S780.

At step S780, the motion controller 33 identifies whether one or more joint mechanisms JE in the specific state are included in the multiple joint mechanisms JE. The position and posture of the hand of the robot 10 are changed to the target position PPk and posture PSk at step 700, and the joint mechanisms JE at the changed position and posture are used at step S780.

When a result of the determination at step S780 is negative, the motion controller 33 returns the processing to step S8. Specifically, after the position and posture of the hand of the robot 10 are changed to the target position PPk and posture PSk at step S700, when no joint mechanism JE in the specific state is included in the multiple joint mechanisms JE, the motion controller 33 returns the processing to step S8. In contrast, when the result at step S780 is affirmative, the motion controller 33 advances the processing to step S782.

At step S782, the motion controller 33 changes the joint values of the joint mechanisms JE in the specific state to joint values that satisfy the following (i) and (ii): (i) each value changed is within the range of motion for the joint mechanism JE in the specific state, and (ii) each value changed takes a value corresponding to the non-specific state. Then, the motion controller 33 returns the processing to step S8. After step S782, in each of the n target states (positions PP and postures PS), an initial joint value of each joint mechanism JE is set to a joint value corresponding to the non-specific state.

The changed joint value at step S782 may take a value that satisfies the following (i) and (ii): (i) the changed value is within the range of motion for the joint mechanism JE in the specific state, and (ii) the changed value that causes a difference between a post-updated value and pre-updated value to be minimum and is within a range of the joint value corresponding to the non-specific state.

Thus, in the operation shown in FIG. 6, the sequence of steps S100 to S520 (the unit processing) is repeated. When one or more joint mechanisms JE in the specific state are included in the multiple joint mechanisms JE in the initial state that comes before the repetition of the unit processing, the joint mechanisms JE in the specific state are changed to joint values corresponding to the non-specific state before the first-time unit processing. Thus, in each of the n target states (the positions PP and postures PS), it is possible to prevent the initial joint value of each joint mechanism JE from changing to the joint value corresponding to the specific state. Consequently, it is possible to prevent the joint mechanisms JE that have changed to the specific state in the k-th target state from being fixed to the specific state after the (k+1)-th subsequent target states.

In the operation shown in FIG. 6, step S7Δθ may be after step S760, or it may be in conjunction with step S760.

With reference to FIG. 7, another example will now be given of the operation of the robot controller 30 by which the robot 10 is changed to the final target state via one or more target states.

FIG. 7 is a flow chart showing another example of operation of the robot controller 30 by which a position and posture of the hand of the robot 10 is sequentially changed to one or more target positions PP and postures PS. The operation shown in FIG. 7 is similar to that shown in FIG. 4. However, update processing at step S140A is performed instead of update processing at step S1Δθ shown in FIG. 4, and a sequence of steps S10 to S50 is incorporated into the operation shown in FIG. 4. Main descriptions will be given below of the sequence of steps S10 to S50.

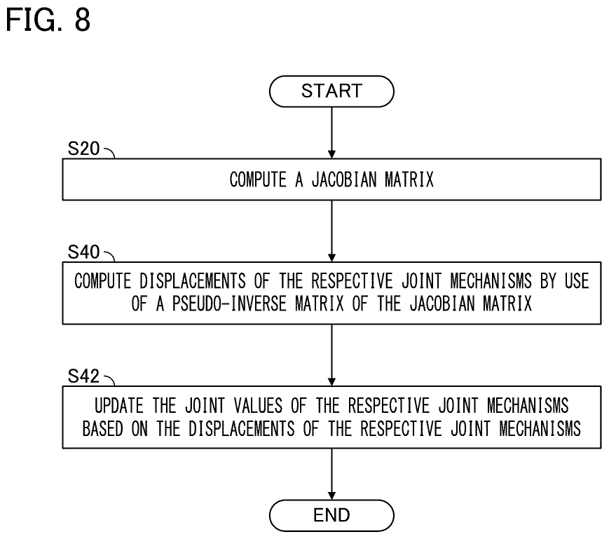

Steps S10, S12, and S50 are identical to steps S100, S120, and S500, respectively. First-time update processing at step S14 is given by omitting steps S300 and S320 from the update processing at step S140A. The first-time update processing at step S14 will be described later with reference to FIG. 8.

After step S8, the motion controller 33 advances the processing to step S10.

At step S10, in a manner similar to step S100, the motion controller 33 computes a difference between (i) a position and posture of the hand of the robot 10 and (ii) the target position PPk and posture PSk. At step S12, in a manner similar to step S120, the motion controller 33 then determines whether the computed difference is below the acceptable value.

When a result of the determination at step S12 is affirmative, the motion controller 33 advances the processing to step S700. In contrast, if the determination at step S12 is negative, the motion controller 33 advances the processing to step S14.

At step S14, the motion controller 33 performs the first-time updating processing in a manner similar to the sequence of steps S200, S400, and S420. By the first-time update processing at step S14, joint values of the respective joint mechanisms JE are updated for the first time.

After the first-time update processing at step S14, the motion controller 33 increments the number of loopings by one at step S50 and advances the processing to step S100.

With reference to FIG. 8, description will now be given of the first-time update processing at step S14.

FIG. 8 is a flowchart showing an example of the first-time update processing shown in FIG. 7. In one example, as the first-time update processing at step S14 shown in FIG. 7, the processing device 32 that acts as the motion controller 33 performs a sequence of steps S20 to S42 shown in FIG. 8. Step S20 is performed when a result of the determination at step S12 shown in FIG. 4 is negative. After step S42, step S50 shown in FIG. 7 is performed.

At step S20, in a manner similar to step S200, the motion controller 33 computes the Jacobian matrix J based on the current joint values of the respective joint mechanisms JE. The motion controller 33 then advances the processing to step S40.

At step S40, in a manner similar to step S400, the motion controller 33 computes displacements of the respective joint mechanisms JE using the pseudo-inverse matrix J⁺ of the Jacobian matrix J. The motion controller 33 then advances the processing to step S42.

At step S42, in a manner similar to step S420, the motion controller 33 updates the joint values of the respective joint mechanisms JE based on the displacements of the respective joint mechanisms JE. The motion controller 33 then advances the processing to step S50 shown in FIG. 7.

Thus, the first-time update processing shown in FIG. 8 involves no steps S300 and S320 (the fixation processing) shown in FIG. 3. In the first-time update processing shown in FIG. 8, the joint values of the respective joint mechanisms JE are updated regardless of whether the joint mechanisms JE are in the specific state. Consequently, one or more joint values of the respective joint mechanisms JE in the specific state after step S700 in the (k−1)-th target state may be updated to joint values of the respective joint mechanisms JE in the non-specific state. In this case, from among the repeated unit processing (the sequence of steps S100 to S520), the first-time unit processing is prevented from starting from the joint value corresponding to the specific state.

However, in the first-time update processing shown in FIG. 8, a joint value of each joint mechanism JE in the specific state may be updated to exceed the range of motion. Specifically, the first-time update processing is repeated for each update of the target position PPk and posture PSk, and thereby each joint value of the joint mechanism JE in the specific state may be repeatedly updated to exceed the range of motion.

Based on the fact, a range of the extra space for movement for a joint in the specific state is greater than a displacement of change in a joint value by one update. When several updates (n times) of a joint value that cause its joint mechanism JE to exceed the range of motion, the range of the extra space is greater than the total of displacements of the updated joint values. Alternatively, in the operation shown in FIG. 7, the same steps S780 and S782 shown in FIG. 6 may be performed between step S14 and step S100.

With reference to FIG. 9 to FIG. 20, an example will now be given of simulation to set a position and posture of the hand of the robot 10 to the target position and posture.

FIG. 9 illustrates description of a simulation model.

To facilitate understanding of the simulation, a modeled robot 10 with the joint mechanisms JEe (JEe1 and JEe2) is used instead of the robot with the joint mechanisms JEp (JEp1 and JEp2) shown in FIG. 1. In controlling motors MO for driving the respective joint mechanisms JE, the robot 10 shown in FIG. 9 is also controlled in the same way as the robot 10 shown in FIG. 1. In one example, in the robot 10 shown in FIG. 9, a link LK1A extends and retracts, and therefore the joint mechanism JEr3 moves along the direction of extension of the link LK1A. Furthermore, the link LK2A with two ends extends and retracts. As a result, one end to which the articulation mechanism JEr4 is connected moves relative to the joint mechanism JEr3 along the direction of extension of the link LK2A. First, the joint mechanisms JEe1 and JEe2 will be described.

The joint mechanism JEe1 is a prismatic joint by which the link LK1A extends and retracts along an axis Axe1. The joint mechanism JEe1 is an example of a “first extension and retraction mechanism.” The link LK1A includes a support portion LK1a, a movable portion LK1b, and a movable portion LK1c. The joint mechanism JEe2 is a prismatic joint by which the link LK2A extends and retracts along an axis Axe2. The joint mechanism JEe2 is an example of a “second extension and retraction mechanism.” The link LK2A includes a support portion LK2a, a movable portion LK2b, and a movable portion LK2c. The axis Axe1 extends along the link LK1A, and the axis Axe2 extends along the link LK2A.

The link LK1A is an example of a “first link,” and the link LK2A is an example of a “second link.” The support portion LK1a is an example a “first support portion” and is connected to a base body BDP via a joint mechanism JEr2. The movable portion LK1c is an example of a “first movable portion” and is connected to the support portion LK2a of the link LK2A via a joint mechanism JEr3. The support portion LK2a is an example of a “second support portion.” The movable portion LK2c is an example of a “second movable portion” and is connected to an end section TP1 via a joint mechanism JEr4.

In one example, the movable portion LK1b is connected to the movable portion LK1c so as to move together with the movable portion LK1c. The movable portion LK1b is also connected to the support portion LK1a so as to move relative to the support portion LK1a. The movable portion LK1b moves, by the joint mechanism JEe1, along the axis Axe1 relative to the support portion LK1a, and thereby the movable portion LK1c moves along the axis Axe1 relative to the support portion LK1a. As a result, the link LK1A extends and retracts along the axis Axe1.

In one example, the movable portion LK2b is connected to the movable portion LK2c so as to move together with the movable portion LK2c. The movable portion LK2b is also connected to the support portion LK2a so as to move relative to the support portion LK2a. The movable portion LK2b moves, by the joint mechanism JEe2, along the axis Axe2 relative to the support portion LK2a, and thereby the movable portion LK2c moves along the axis Axe2 relative to the support portion LK2a. As a result, the link LK2A extends and retracts along the axis Axe2.

As shown in FIG. 9, some coordinate systems ΣIn introduced in the simulation model correspond one-to-one to the joint mechanisms JE. The coordinate systems 2 are numbered from “1” to “8” in ascending order of a distance between the base body and each joint mechanism JE. The joint mechanism JEr1 is a first joint, the joint mechanism JEr2 is a second joint, and the joint mechanism JEe1 is a third joint. The joint mechanism JEr3 is a fourth joint, the joint mechanism JEe2 is a fifth joint, and the joint mechanism JEr4 is a sixth joint. The joint mechanism JEr5 is a seventh joint, and the joint mechanism JEr6 is a eighth joint.

A coordinate system Σi for the i-th joint mechanism JE (i.e., the i-th joint) is a three-axis orthogonal coordinate system with an Xi axis, a Yi axis, and a Zi axis orthogonal to each other. In this case, in the example shown in FIG. 9, the “i” indicates a natural number of one or more and eight or less. The coordinate system Σ8 for the eighth joint mechanism JEr6 corresponds to a coordinate system of the end section of the robot 10. In FIG. 9, a Y-axis of each of the coordinate systems Σ1 to Σ7 is omitted for the sake of clarity in the drawing.

In one example, when the i-th joint mechanism JE is a rotation joint, the Zi axis of the coordinate system Σi corresponds to a rotation axis of the i-th joint mechanism JE. When the i-th joint mechanism JE is a prismatic joint, the Zi axis corresponds to an axis of extension and retraction of the link LK moved by the i-th joint mechanism JE. In one example, an Xi axis of the coordinate system Zi is, basically, a common-normal line between a Zi axis and a Zi+1 axis.

The i-th joint mechanism JE is associated with an element J1 of the i-th column of the Jacobian matrix J. In the Jacobian matrix J, an element J1 on the first column represents the joint mechanism JEr1, an element J2 on the second column represents the joint mechanism JEr2, and an element J3 on the third column represents the joint mechanism JEe1. An element J4 on the fourth column represents the joint mechanism JEr3, an element J5 on the fifth column represents the joint mechanism JEe2, and an element J6 on the sixth column represents the joint mechanism JEr4. An element J7 on the seventh column represents the joint mechanism JEr5, and an element J8 on the eighth column represents the joint mechanism JEr6.

Setting of the simulation was as follows: the link length L1 between the origins of the reference coordinate system 20 and the coordinate system Σ1 was 0.2409 m. The link length L6 between the origins of the coordinate systems 25 and 26 was 0.1 m (the link length L6 had a parameter of −0.1 m in the simulation). The link length L7 between the origins of the coordinate systems Σ6 and Σ7 was 0.1 m. The link length L8 between the origins of the coordinate systems 27 and Σ8 was 0.05 m. A range of motion (extension and retraction) for the link LK1A moved by the joint mechanism JEe1 was from 0.25 m to 0.5 m. A range of motion (extension and retraction) for the link LK2A moved by the joint mechanism JEe2 was from 0.3 m to 0.5 m.

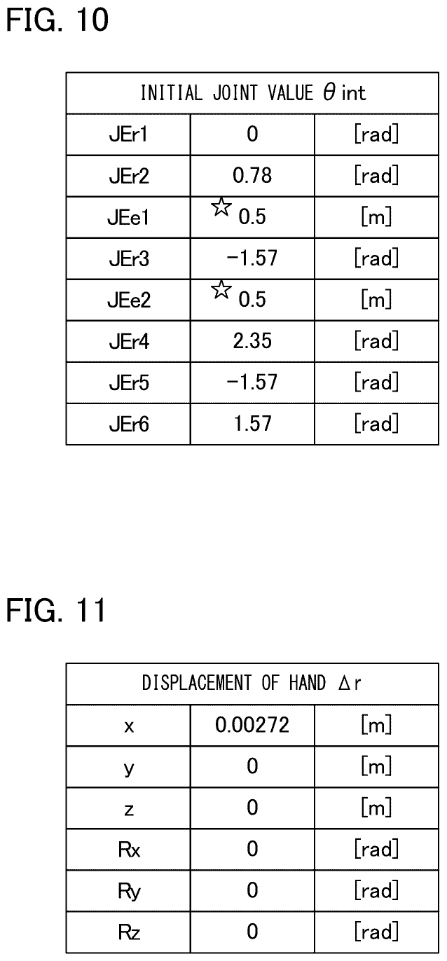

In the simulation, the hand of the robot 10 moved in the positive direction of the axis X0. As shown in FIG. 10, initial joint values of the respective joint mechanisms JE of the robot 10 are denoted by θint.

FIG. 10 illustrates description of initial joint values θint of the simulation model shown in FIG. 9.

FIG. 10, an upper star mark, shows that an initial joint value θint of the joint mechanism JEe1 is 0.5 m, which is an upper limit of the range of motion for the link LK1A. FIG. 10, a lower star mark, shows that an initial joint value θint of the joint mechanism JEe2 is 0.5 m, which is an upper limit of the range of motion for the link LK2A. The joint mechanisms JEe1 and JEe2 are in the limit condition.

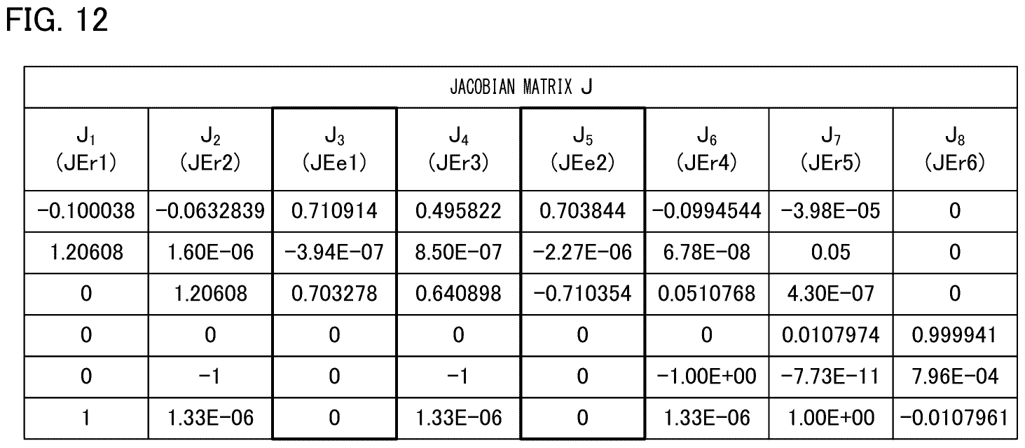

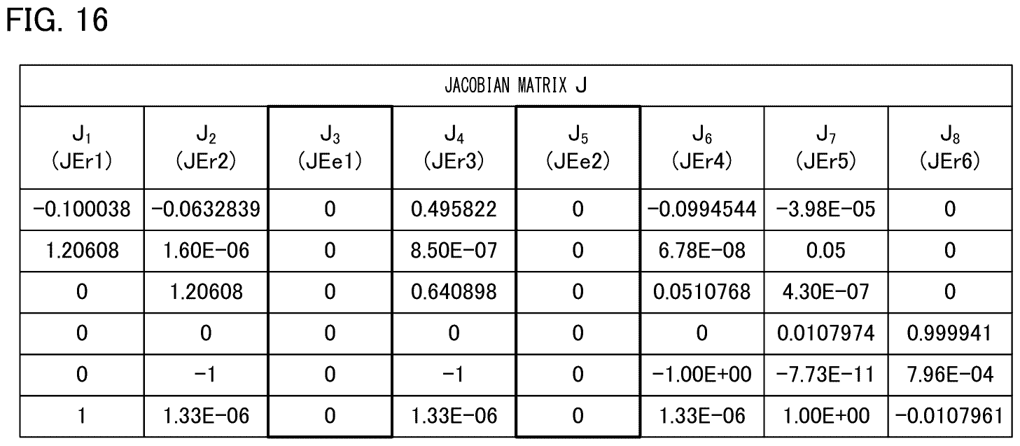

Based on the fact, in this embodiment shown in FIG. 16 (which will be described later), from among the multiple of the elements of the Jacobian matrix J, the element J3 for the joint mechanism JEe1 is zero, and the element J4 for the joint mechanism JEe2 is also zero. In contrast, as shown in FIG. 12, the comparative control method without the fixation processing involves no fixation for the elements J3 and J4.

FIG. 11 illustrates description of a displacement Δr of the hand used in the simulation. In this simulation, the jog motion was performed to move the hand of the robot 10 by 0.00272 m in the positive direction of the X0 axis. FIG. 11 shows that the displacement Δr of the hand in the positive direction of the axis X0 is 0.00272 m.

In this simulation, as described above, the hand of the robot 10 moved by 0.00272 m in the positive direction of the X0 axis from the limited state indicating that the links LK1A and LK2A were extended up to the upper limit by the joint mechanisms JEe1 and JEe2. A displacement Δθ of each joint relative to the displacement Δr of the hand is computed from Formula (7) of “θᵢ(•)=J⁺ r (•).” The displacement Δθ of each joint is then added to a corresponding initial joint value θint, and a final joint value θend of each joint after completion of movement of the hand i is computed.

First, with reference to FIGS. 12 to 15, description will now be given of simulation of the comparative control method without the fixation processing.

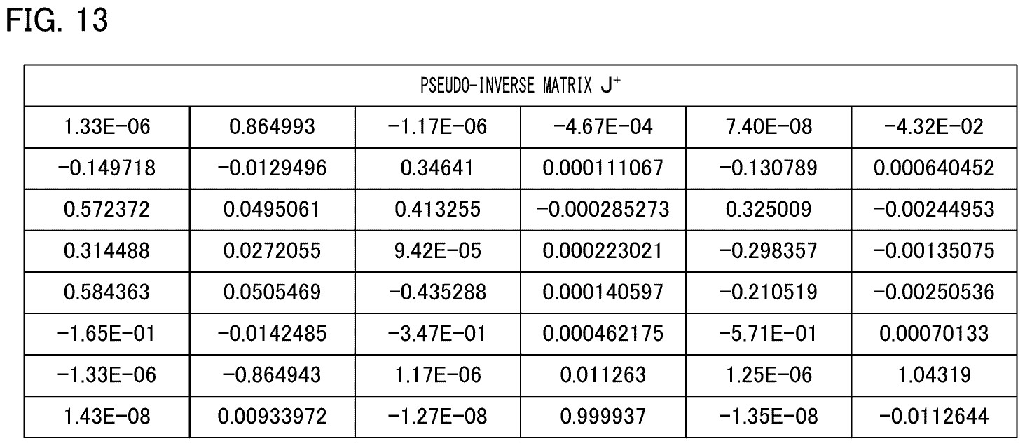

FIG. 12 illustrates description of a Jacobian matrix J used in the comparative control method. FIG. 13 illustrates description of a pseudo-inverse matrix J⁺ of the Jacobian matrix J shown in FIG. 12.

The Jacobian matrix J is computed based on the simulation model described in FIG. 9 and the initial joint values θint shown in FIG. 10. A method for computing the Jacobian matrix J may be freely chosen, and description thereof is omitted. The comparative control method involves computation of the Jacobian matrix J on the assumption that all the eight joint mechanisms JE (eight axes Ax) move. FIG. 12 shows that the elements J3 and J4 for the respective joint mechanisms JEe1 and JEe2 in the limit condition are not fixed to values of zero.

The pseudo-inverse matrix J⁺ (see FIG. 13) is computed from the Jacobian matrix J (see FIG. 12). A method for computing the pseudo-inverse matrix J⁺ may be freely chosen, and description thereof is omitted. From Formula (7) of the pseudo-inverse matrix J⁺, displacements Δθ of the joints are computed as shown in FIG. 13.

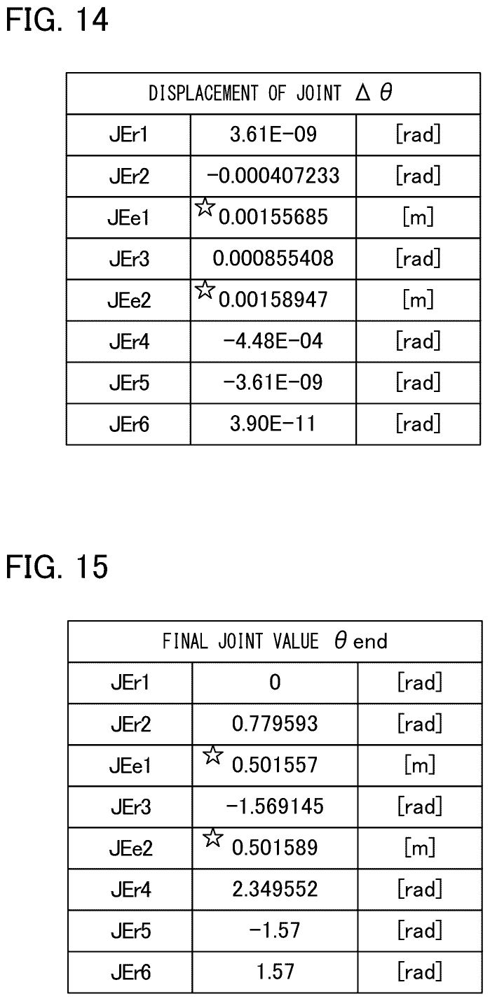

FIG. 14 shows displacements Δθ of the joints computed using the pseudo-inverse matrix J⁺ shown in FIG. 13. The comparative control method involves no fixation processing, and therefore, displacements Δθ of the joints for the joint mechanisms JEe1 and JEe2 in the limited state (see star marks in FIG. 14) are computed. If the displacements Δθ of the joints (see FIG. 14) are used to compute final joint values θend after completion of movement of the hand, the joint mechanisms JEe1 and JEe2 are out of the range of motion, as shown in FIG. 15.

FIG. 15 shows final joint values θend computed based on the displacements Δθ of the joints shown in FIG. 14. The final joint values θend are computed by adding the displacements Δθ of the joints shown in FIG. 14 to the initial joint values θint shown in FIG. 10. The final joint values θend shown in FIG. 15 are given by rounding to seventh decimal places, the added result of the displacements Δθ to the initial joint values θint.

FIG. 15, an upper star mark, shows that a final joint value θend of the joint mechanism JEe1 exceeds 0.5 m, which is the upper limit of the range of motion for the link LK1A. FIG. 15, a lower star mark, also shows that a final joint value θend of the joint mechanism JEe2 also exceeds 0.5 m, which is the upper limit of the range of motion for the link LK2A. Thus, the comparative control method fails to provide correct solutions for the computation of inverse kinematics (solutions that satisfy the joint mechanisms JE moving within the range of motion). An incorrect result from the computation does not allow the robot 10 to operate correctly.

With reference to FIGS. 16 to 19, description will now be given of simulation of the fixation processing according to this embodiment.

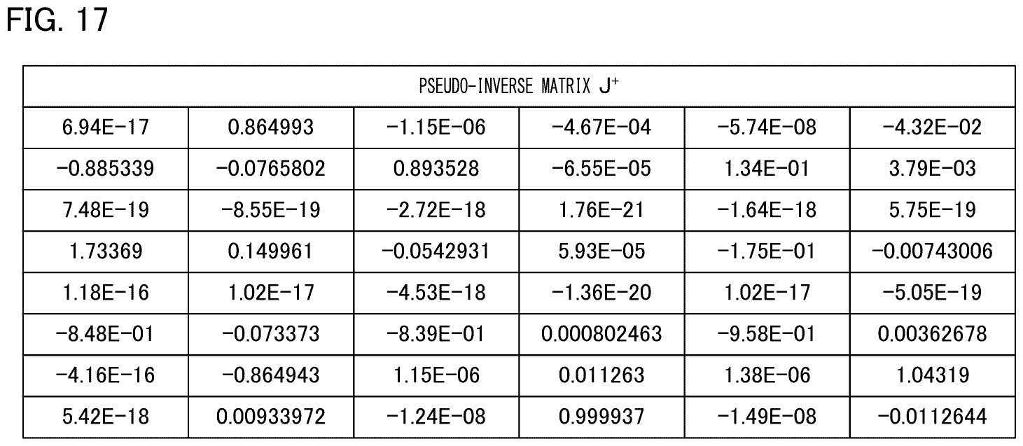

FIG. 16 illustrates description of a Jacobian matrix J when joint mechanisms JE in the specific state are fixed. FIG. 17 illustrates description of a pseudo-inverse matrix J⁺ of the Jacobian matrix J shown in FIG. 16.

The joint mechanisms JEe1 and JEe2 are in the limited state, as described in FIG. 10. This means that the joint mechanisms JEe1 and JEe2 are in the specific state. In the specific state, there remains play in movement of each joint compared to the limited state. Based on the fact, in this embodiment, as shown in FIG. 16, from among the multiple elements of the Jacobian matrix J, the elements J3 and J4 for the respective joint mechanisms JEe1 and JEe2 in the specific state are set to values of zero. In other respects, the Jacobian matrix J shown in FIG. 16 is similar to that shown in FIG. 12. However, the elements J3 and J4 are set to values of zero.

Thus, in this embodiment, the elements J3 and J4 are set to values of zero. As a result, the joint mechanisms JEe1 and JEe2 for the respective elements J3 and J4 are regarded as fixed joints (without displacements), and thereby computation of inverse kinematics can be performed.

Specifically, the pseudo-inverse matrix J⁺ (see FIG. 17) is computed from the Jacobian matrix J (see FIG. 16). From Formula (7) of the pseudo-inverse matrix J⁺, displacements Δθ of the joints are computed as shown in FIG. 17.

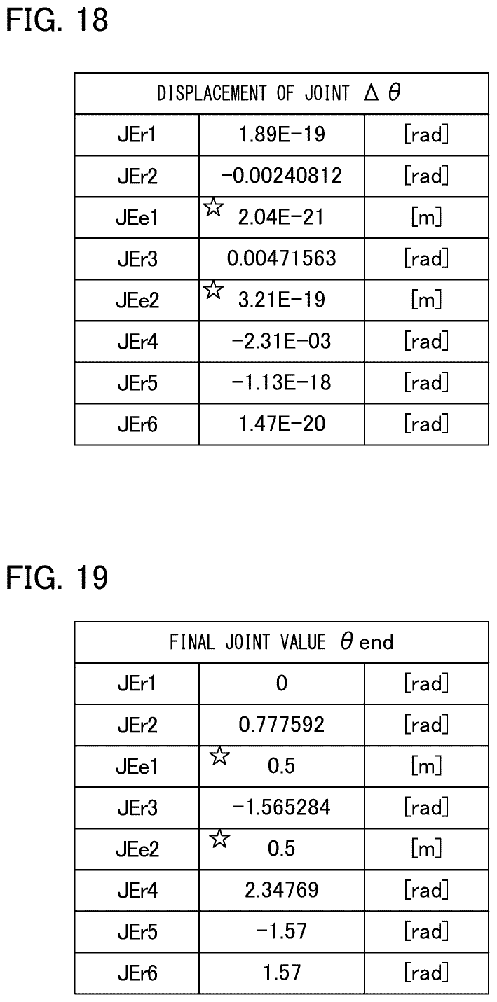

FIG. 18 shows displacements Δθ of the joints computed using the pseudo-inverse matrix J⁺ shown in FIG. 17. In this embodiment, the elements J3 and J4 of the Jacobian matrix J are set to values of zero. As a result, displacements Δθ of the joint mechanisms JEe1 and JEe2 for the elements J3 and J4 are regarded as zero (see star marks in FIG. 17).

Thus, in this embodiment, the displacements Δθ of the joint mechanisms JEe1 and JEe2 in the limited state are regarded as zero. Upon computation of the final joint values θend by use of the displacements Δθ shown in FIG. 18, the joint mechanisms JEe1 and JEe2 based on the calculated final joint values θend are within the range of motion, as shown in FIG. 19.

FIG. 19 shows final joint values θend computed based on the displacements Δθ of the joints shown in FIG. 18. The final joint values θend are computed by adding the displacements Δθ of the joints shown in FIG. 18 to the initial joint values θint shown in FIG. 10. In a manner similar to that for the final joint values θend shown in FIG. 15, the final joint values θend shown in FIG. 19 are given by rounding seventh decimal places, the added result of the displacements Δθ to the initial joint values θint.

FIG. 19, an upper star mark, shows that a final joint value θend of the joint mechanism JEe1 is 0.5 m, which is the upper limit of the range of motion for the link LK1A. This final joint value θend is the same as the initial joint value θint of the joint mechanism JEe1. FIG. 19, a lower star mark, also shows a final joint value θend of the joint mechanism JEe2 0.5 m, which is the upper limit of the range of motion for the link LK2A. This final joint value θend is the same as the initial joint value θint of the joint mechanism JEe2. Thus, this embodiment provides correct solutions for the computation of inverse kinematics (solutions that satisfy the joint mechanisms JE moving within the range of motion).

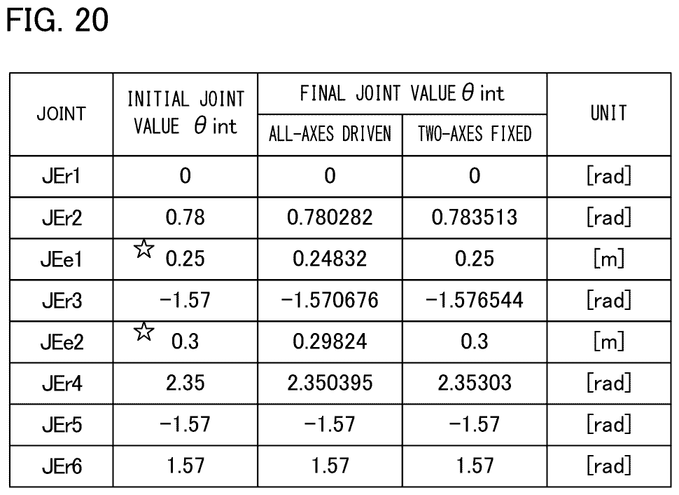

FIG. 20 illustrates the description of results of the simulation from initial joint values θint that differ from those shown in FIG. 10.

FIG. 20, an upper star mark, shows that an initial joint value θint of the joint mechanism JEe1 is 0.25 m, which is the lower limit of the movable range of the link LK1A. FIG. 20, a lower star mark, also shows that an initial joint value θint of the joint mechanism JEe2 is 0.3 m, which is the lower limit of the range of motion for the link LK2A. In short, the joint mechanisms JEe1 and JEe2 are in the limited state. In this simulation, the jog motion was performed to move the hand of the robot 10 by 0.00272 m in the negative direction of the axis X0 axis. A displacement Δr of the hand along the axis X0 was-0.00272 m, and the remaining displacement other than the axis X0 was 0 m.

In this simulation, the hand of the robot 10 moved by 0.00272 m in the negative direction of the axis X0 from the limited state indicating that the links LK1A and LK2A moved by the joint mechanisms JEe1 and JEe2 contracted to the lower limit.

FIG. 20 shows two types of result of the simulation. One of the two is obtained by the comparative control method without the fixation processing (all-axes driven), and the other is obtained by the control method with the fixation processing according to this embodiment (two-axes fixed).

The comparative control method involves computation of a pseudo-inverse matrix J⁺ of the Jacobian matrix J under the assumption that all axes are driven. The method further involves use of the obtained pseudo-inverse matrix J⁺ to compute displacements Δθ of the joints. As a result, as shown on a column “all-axes driven” of the final joint values θend in FIG. 20, the joint mechanisms JEe1 and JEe2 are out of the range of motion. Specifically, a final joint value θend of the joint mechanism JEe1 is less than 0.25 m, which is the lower limit of the range of motion for the link LK1A. A final joint value θend of the joint mechanism JEe2 is less than 0.3 m, which is the lower limit of the range of motion for the link LK2A.

In contrast, the control method according to this embodiment involves the set of elements J3 and J4 for the respective joint mechanisms JEe1 and JEe2 in the limited state to values of zero. The control method further involves use of the set of pseudo-inverse matrix J⁺ of the Jacobian matrix J to compute displacements Δθ of the joints. As a result, as shown in “two-axes fixed” of FIG. 20, the joint mechanisms JEe1 and JEe2 are maintained within the range of motion. Specifically, a final joint value θend of the joint mechanism JEe1 is 0.25 m, which is the lower limit of the motion of range for the link LK1A, and the final joint value θend of the joint mechanism JEe2 is 0.3 m, which is the lower limit of the range of motion for the link LK2A.

Thus, in the jog motion for one or more joint mechanism JE in the limited state, the computation of inverse kinematics on all axes (eight axes) causes such joint mechanisms JE to exceed the range of motion. In contrast, in this embodiment, one or more joint mechanisms JE in the limited state are regarded as fixed joints, to perform the computation of inverse kinematics on the rest six axes. As a result, the joint mechanisms JE in the limited state remains unchanged. This result enables the jog motion to be continued within the range of motion for the joint mechanisms JE.

FIGS. 9 to 20 show the simulation for two joint mechanisms JE in the limited state; however, the number of joint mechanisms JE in the limited state is not limited to two. In one example, there may be one joint mechanism JE in the limited state. Alternatively, there may be three or more and less than m joint mechanisms JE in the limited state. Where, m is the total number of joint mechanisms JE. A joint mechanism JE in the specific state may be regard as a fixed joint (there remains play in movement thereof).

Some scenarios will now be given of application of the computation of inverse kinematics. A first scenario is for the jog motion of the robot 10. In the jog motion, instructions on a target position for the robot 10 are given, and the computation of inverse kinematics is used to compute angles (displacements) of the respective joints that allow the hand to move to the instructed target position. A second scenario is for generation of a trajectory of the robot 10. For repetitive motion of the robot 10, the robot 10 needs to store its trajectory in advance. In generating the trajectory in advance, the computation of inverse kinematics is used to compute angles of the joints at the respective points on the trajectory. If a few points are given for the trajectory, the trajectory may be generated by supplementing points during actual operation of the robot 10. A third scenario is for generation (or modification) of a trajectory of the robot 10 including a vision camera on the basis of vison information. Instructions on a new target position are also given in a manner similar to the first scenario.

In the foregoing embodiment, the robot system 1 includes the articulated robot 10 with seven or more mechanisms JE, and the robot controller 30 that controls operation of the robot 10.

A method for controlling the robot 10 includes repeating unit processing including computation processing and fixation processing. The computation processing is for (i) computing displacements of the respective joint mechanisms JE by use of computation of inverse kinematics, in which, the displacements of the respective joint mechanisms JE cause the robot 10 to operate, and (ii) updating joint values of the respective joint mechanisms JE based on the displacements. The fixation processing is performed on a joint mechanism JE in a specific state from among the joint mechanisms JE, in which, the specific state is preset and is determined based on a corresponding joint value. For example, in the specific state, a constraint on the displacement is satisfied (a limited state), and there remains play in movement of a joint compared to the limited state. When the fixation processing is performed, the computation processing includes changing, from among the joint mechanisms JE, joint values of respective joint mechanisms JE in a non-specific state without substantially changing a joint value of the joint mechanism JE in the specific state.

The specific state may be set to a certain joint mechanism JE from among the joint mechanisms JE. In the specific state, within a range of motion for the certain joint mechanism JE, the joint value may take a value of a boundary range between an inside and outside of the range of motion.

The robot controller 30 includes a motion controller 33 that repeats the unit processing. In one example, by the control program PGr, the processing device 32 included in the robot controller 30 acts as the motion controller 33.

Thus, in this embodiment, one or more joint mechanisms JE in the specific state are regarded as fixed joints in which the states of the joint mechanisms JE remain unchanged, and the computation of inverse kinematics is performed using the rest joint mechanisms JE. The computation of inverse kinematics can be performed without displacing the joint mechanisms JE in the specific state. As a result, this embodiment provides correct solutions for the computation of inverse kinematics (solutions that satisfy the joint mechanisms JE moving within the range of motion). In other words, it is possible to reduce a frequency of incorrect results from the computation of inverse kinematics (no solutions that satisfy the joint mechanisms JE moving within the range of motion). This result archives continuous operation of the robot 10 within the range of motion for the joint mechanisms JE.

In this embodiment, when one or more joint mechanisms JE in the specific state are included in the multiple joint mechanisms JE, the robot controller 30 may cancel update of joint values of the respective joint mechanisms JE. In such a case, when one or more joint mechanisms JE in the specific state are included in the multiple joint mechanisms JE, the unit processing further includes (i) returning the joint values updated by previous unit processing to first joint values to pre-updated second joint values, and (ii) identifying, based on the first joint values, the joint mechanisms JE in the specific state to be subjected to the fixation processing, and (iii) performing the computation processing after the fixation processing.

According to this embodiment, upon computation of joint values by the computation processing, update to the computed joint values is performed on joint values of the respective joint mechanisms JE in the non-specific state. As a result, it is possible to prevent repetitive unit processing with the joint mechanisms JE fixed to the specific state.

In this embodiment, when one or more joint mechanism JE in the specific state are included in the multiple joint mechanisms JE in an initial state, the initial state coming before the repetitive unit processing, the robot controller 30 may change the joint value of the joint mechanism JE in the specific state to a joint value corresponding to the non-specific state before first-time unit processing of the repeated unit processing.

According to this embodiment, it is possible to prevent the initial joint value of each joint mechanism JE from being a joint value corresponding to the specific state, in the first-time unit processing of the repeated unit processing. As a result, even when one or more joint mechanisms JE in the specific state are included in the multiple joint mechanisms JE in the initial state, it is possible to prevent these joint mechanisms JE from being fixed to the specific state.

In this embodiment, in the computation processing, the robot controller 30 performs the computation of inverse kinematics by use of the Jacobian matrix J. In the fixation processing, from among the multiple elements of the Jacobian matrix J, the robot controller 30 sets to values of substantially zero, one or more elements for the joint values of the respective joint mechanisms JE in the specific state. As a result, the joint values of the respective joint mechanisms JE in the specific state are set to the fixed values. The joint values of the respective joint mechanisms JE can be set to fixed values with ease. In other words, even when one or more joints in the specific state are found, continuous computation of inverse kinematics is performed on the found joint vales without change in the number of rows and columns of the Jacobian matrix J and without division of the Jacobian matrix J into multiple matrices.

In this embodiment, the multiple joint mechanisms JE include at least one prismatic joint (e.g., a joint mechanism JEp or JEe). Even in this case, such a prismatic joint in the specific state close to the upper or lower limit of the range of motion is regarded as a fixed joint, and the computation of inverse kinematics is performed by used of the rest joint mechanisms JE. As a result, a frequency of incorrect results from the computation of inverse kinematics is reduced. This embodiment provides continuous operation of a widely variety of articulated robots with prismatic joints.

In this embodiment, the robot 10 includes the base body BDP, the link LK1, the link LK2, the end section TP1, the joint mechanism JEr1, the joint mechanism JEr2, the joint mechanism JEr3, the joint mechanism JEr4, the joint mechanism JEP1, and the joint mechanism JEp2.

The joint mechanism JEr1 is configured to rotate at least a portion of the base body BDP about the axis Ax1 as a first rotation axis, the axis Ax1 as the first rotation axis forming an angle equal to or less than a predetermined angle with a direction Dv1 perpendicular to a bottom surface BDPbt of the base body BDP.

The joint mechanism JEr2 connects the base body BDP and the link LK1 to each other, and is configured to rotate the link LK1 about the axis Ax2 as a second rotation axis, the axis Ax2 as the second rotation axis forming an angle greater than the predetermined angle with the direction DV1 perpendicular to the bottom surface BDPbt of the base body BDP

The joint mechanism JEr3 connects the link LK1 and the link LK2 to each other, and is configured to rotate the link LK2 relative to the link LK1 about the axis Ax3 as a third rotation axis, the axis AX3 as the third rotation axis forming an angle greater than the predetermined angle with a direction De1 of extension of the link LK1.

The joint mechanism JEr4 connects the link LK2 and the end section TP1 to each other, and is configured to rotate the end section TP1 relative to the link LK2 about the axis Ax4 as a fourth rotation axis, the axis AX4 as the fourth rotation axis forming an angle greater than the predetermined angle with a direction De2 of extension of the link LK2;

The joint mechanism JEP1 is configured to move the joint mechanism JEr3 relative to the link LK1 along the direction De1 of extension of the link LK1.

The joint mechanism JEp2 is configured to move the link LK2 relative to the joint mechanism JEr3 along the direction De2 of extension of the link LK2.

The end section TP1 includes the first portion TP11 connected to the link LK2, the second portion TP12 connected to the first portion TP11, the joint mechanism JEr5, and the joint mechanism JEr6.

The joint mechanism JEr5 connects the first portion TP11 and the second portion TP12 to each other, and is configured to rotate the second portion TP12 relative to the first portion TP 11 about the axis Ax5 as a fifth rotation axis, the axis Ax5 as the fifth rotation axis forming an angle greater than the predetermined angle with the fourth rotation axis.

The joint mechanism JEr6 is configured to rotate at least a portion of the end sectionTP1 about the axis Ax6 as a sixth rotation axis, the axis AX6 as the sixth rotation axis forming an angle greater than the predetermined angle with the fifth rotation axis.

The joint mechanisms include the joint mechanisms JEr1, JEr2, JEr3, JEr4, JEr5, JEr6, JEp1 and JEp2.

Thus, this embodiment provides continuous operation of the articulated robot 10 with six rotary joints and two prismatic joints. In such a robot, the two prismatic joints act as redundant joints in some cases, and the joint values frequently fall in the specific state. Based on the fact, for robots with prismatic joints, as in the simulation described with reference to FIGS. 9 to 20, efficient control of the robots is achieved by the fixation processing on the prismatic joints.

In this embodiment, the robot system 1 may be used in a method for manufacturing an object, in which the manufacturing includes assembling components or removing components. In this case, it is possible to prevent work, such as assembling or removing the components, from stopping due to incorrect results from the computation of inverse kinematics. In other words, this embodiment provides efficient work, such as assembling or removing the components.

### 2. Modifications

This disclosure is not limited to the foregoing embodiment. Specific modifications will be exemplified below. Two or more of the modes optionally selected from the following modifications may be combined with one another.

### First Modification

In the foregoing embodiment, an example is given in which the link LK2 and the end section TP1 are connected to each other by the joint mechanism JEr4. However, this disclosure is not limited to such an aspect. In one example, the joint mechanism JEr4 may be included in the link LK2.

FIG. Σ1 illustrates description of a robot 10 according to the first modification. Elements similar to those described in FIGS. 1 to 9 are denoted by the same reference numerals, and detailed description thereof will be omitted.

The robot 10 according to this modification is an eight-axis articulated robot with joint mechanisms JEe (JEe1 and JEe2), instead of the joint mechanisms JEp (JEp1 and JEp2) shown in FIG. 1. In one example, the robot 10 includes joint mechanisms JEr1A0, JEr2, JEr3A, JEr4A, JEr5A, JEr6, JEe1 and JEe2, a base body BDPa, links LK1A and LK2A, and an end section TP1A. The link LK1A is provided with a joint mechanism JEe1, and the link LK2A is provided with a joint mechanism JEe2 and the joint mechanism JEr4A.

The base body BDPa is an example of a “base.” The joint mechanism JEr1A is an example of a “first driving mechanism,” the joint mechanism JEr3A is an example of a “third driving mechanism,” and the joint mechanism JEr5A is an example of a “fifth driving mechanism.”

The base body BDPa is fixed to a predetermined place (e.g., a floor) via the joint mechanism JEr1A. The joint mechanism JEr1A rotates the base body BDPa relative to a rotation axis Ax1 as the rotation axis. The rotation axis Ax1 is perpendicular to a bottom surface BDPbt of the base body BDPa.

The joint mechanism JEr2 connects the base body BDPa with the support portion LK1a of the link LK1A. The joint mechanism JEr2 rotates the link LK1A relative to the base body BDPa about an axis Ax2 as a rotation axis. The axis Ax2 is parallel to the bottom surface BDPbt of the base body BDPa.

In one example, the link LK1A is extendable and retractable along a direction De1 of extension of the link LK1A. Specifically, the link LK1A includes a support portion LK1a connected to the base body BDPa, movable portions LK1b and LK1c, and the joint mechanism JEe1. In one example, the link LK2A is extendable and retractable along a directional De2 of extension of the link LK2A. Specifically, the link LK2A includes a support portion LK2a connected to the movable portion LK1c of the link LK1A, movable portions LK2b and LK2c, the joint mechanisms JEe2 and JEr4A.

The links LK (LK1A and LK2A) and the joint mechanisms JEe (JEe1 and JEe2) are described in FIG. 9, and thus detailed explanation thereof is omitted. In one example, the support portion LK1a is hollow. Upon contraction of the link LK1A, at least a part of the movable portion LK1b is housed within the support portion LK1a. In one example, the support portion LK2a is also hollow. Upon contraction of the link LK2A, at least a part of the movable portion LK2b is housed within the support portion LK2a.

The joint mechanism JEr3A connects the movable portion LK1c of the link LK1A with the support portion LK2a of the link LK2A. The joint mechanism JEr3A rotates the link LK2A relative to the link LK1A about an axis Ax3 as a rotation axis. The axis Ax3 is perpendicular to a direction De1 of extension of the link LK1A.

The joint mechanism JEr4A rotates the movable portion LK2c relative to the support portion LK2a about an axis Ax4A as a rotation axis. The axis Ax4A is parallel to the direction De2 of extension of the link LK2A. The joint mechanism JEr4A is an example of a “fourth driving mechanism,” and the axis Ax4A is an example of a “fourth rotation axis.”

The joint mechanism JEr5A connects the movable portion LK2c of the link LK2A with the end section TP1A. The joint mechanism JEr5A rotates the end section TP1A relative to the link LK2A about an axis Ax5 as a rotation axis. The axis Ax5 is perpendicular to the direction De2 of extension of the link LK2A.

The end section TP1A includes a second portion TP12A connected to the movable portion LK2c of the link LK2 via the joint mechanism JEr5A, and the articulation mechanism JEr6. The joint mechanism JEr6 is identical to that shown in FIG. 1.

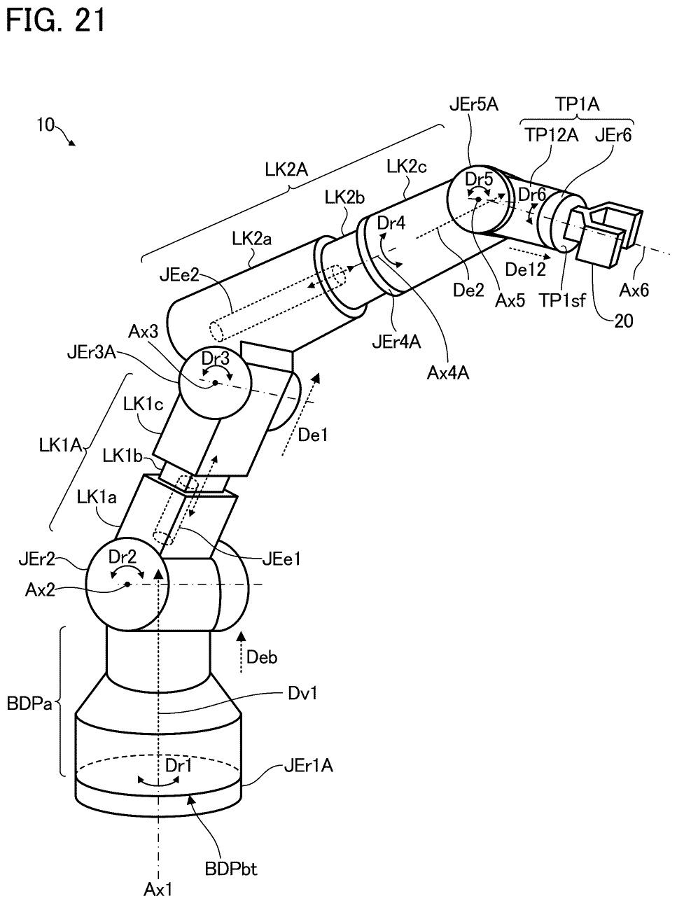

The configuration of the robot 10 according to this modification is not limited to the example shown in FIG. 21. In the example of FIG. 21, the joint mechanism JEr4A moves relative to the support portion LK2a along the direction De2 so as to move together with the movable portion LK2c of the link LK2A. The joint mechanism JEr4A, however, may be fixed to the link LK2A. The joint mechanism JEr4A may rotate the movable portion LK2b relative to the support portion LK2a about the axis Ax4A as a rotation axis, and the joint mechanism JEe2 may move the movable portion LK2c relative to the movable portion LK2b. If the movable portion LK2c is configured to move relative to the movable portion LK2b, the movable portion LK2b may be hollow. Upon contract of the link LK2A, at least a part of the movable portion LK2c is housed within the movable portion LK2b. Either the articulation mechanism JEe1 or JEe2 may be omitted.

In the foregoing modification, the robot 10 includes a base body BDPa, the link LK1A including the support portion LK1a and the movable portion LK1c, the link LK2A including the support portion LK2a and the movable portion LK2c, the end section TP1A, the joint mechanism JEr1A, the joint mechanism JEr2, the joint mechanism JEr3A, the joint mechanism JEr4A, the joint mechanism JEr5A, the joint mechanism JEr6, the joint mechanism JEe1, and the joint mechanism JEe2.

The joint mechanism JEr1A is configured to rotate at least a portion of the base body BDPa about the axis Ax1 as a first rotation axis, the axis Ax1 as the first rotation axis forming an angle equal to or less than a predetermined angle with the direction Dv1 perpendicular to the bottom surface BDPbt of the base body BDPa.

The joint mechanism JEr2 connects the base body BDPa and the support portion LK1a to each other, and is configured to rotate the link LK1A relative to the base body BDPa about the axis Ax2 as a second rotation axis, the axis Ax2 as the second rotation axis forming an angle greater than the predetermined angle with the direction Dv1 perpendicular to the bottom surface BDpbt of the base body BDPa.

The joint mechanism JEr3A connects the movable portion LK1c and the support portion LK2a to each other, and is configured to rotate the link LK2A relative to the link LK1A about the axis Ax3 as a third rotation axis, the axis Ax3 as the third rotation axis forming an angle greater than the predetermined angle with a direction De1 of extension of the link LK1A.

The joint mechanism JEr4A is configured to rotate the movable portion LK2c relative to the support portion LK2a about the axis Ax4A as a fourth rotation axis, the axis Ax4A as the fourth rotation axis forming an angle equal to or less than the predetermined angle with the direction De2 of extension of the link LK2A.

The joint mechanism JEr5A connects the movable portion LK2c and the end section TP1A to each other, and is configured to rotate the end section TP1A relative to the link LK2A about the axis Ax5 as a fifth rotation axis, the axis Ax5 as the fifth rotation axis forming an angle greater than the predetermined angle with the direction De2 of extension of the link LK2A. The joint mechanism JEr6 is configured to rotate at least a portion of the end section TP1A relative to the link LK2A about the axis Ax6 as a sixth rotation axis, the axis Ax6 as the sixth rotation axis forming an angle greater than the predetermined angle with the fifth rotation axis.

The joint mechanism JEe1 is configured to extend and retract the link LK1A by moving the movable portion LK1c relative to the support portion LK1a along the direction De1 of extension of the link LK1A.

The joint mechanism JEe2 is configured to extend and retract the link LK2A by moving the movable portion LKc2 relative to the support portion LK2a along the direction De2 of extension of the link LK2A.

The multiple joint mechanisms JE include the joint mechanisms JEr1A, JEr2, JEr3A, JEr4A, JEr5A, JEr6, JEe1, and JEe2.

This modification provides the same effects as those of the foregoing embodiment.

### Second Modification

In the foregoing embodiment, the joint mechanism JEr4 rotates the end section TP1 relative to the link LK2 about the axis Ax4, which is perpendicular to the direction De2 of extension of the link LK2. However, this disclosure is not limited to this aspect. In one example, the joint mechanism JEr4 may rotate the end section TP1 relative to the link LK2 about an axis that forms an angle equal to or less than a predetermined angle with the direction De2.

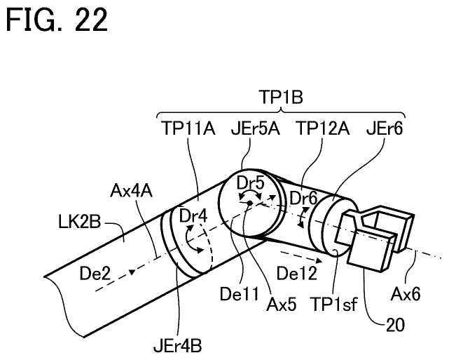

FIG. 22 illustrates description of an end section TP1B according to the second modification. Elements substantially the same as those described in FIGS. 1 to 21 are denoted by like reference signs, and detailed explanations thereof are omitted.

In one example, the robot 10 according to this modification is similar to the robot 10 shown in FIG. 1. However, the robot 10 according to this modification includes a link LK2B, a joint mechanism JEr4B, and an end section TP1B, instead of the link LK2, the joint mechanism JEr4, and the end section TP1 as shown in FIG. 1. The link LK2B is similar to the link LK2. However, the link LK2B is connected to the joint mechanism JEr4B, instead of the joint mechanism JEr4. The link LK2B is an example of a “second link,” and the joint mechanism JEr4B is an example of a “fourth driving mechanism.”

The joint mechanism JEr4B connects the link LK2B and the end section TP1B to each other. The joint mechanism JEr4B rotates the end section TP1B relative to the link LK2B about an axis Ax4A as a rotation axis. The axis Ax4A is parallel to a direction De2. A rotational direction Dr4 shown in FIG. 22 indicates a rotational direction of the end section TP1B when the end section TP1B rotates about the axis Ax4A as a rotation axis. The axis Ax4A is an example of a “fourth rotation axis,” and corresponds to an axis that forms an angle equal to or less than a predetermined with the direction De2 of extension of the link LK2B.

In a manner similar to the end section TP1 shown in FIG. 1, an end effector 20 is attached to an end surface TP1sf of the end section TP1B. The end section TP1B includes a first portion TP11A connected to the link LK2B, a second portion TP12A connected to the first portion TP11A, a joint mechanism JEr5A, and a joint mechanism JEr6. The first portion TP11A is connected to the link LK2B via the joint mechanism JEr4B, and thereby the first portion TP11A rotates relative to the link LK2B about the axis Ax4A as a rotation axis.

The joint mechanism JEr5A connects the first portion TP11A and the second portion TP12A to each other. The joint mechanism JEr5A rotates the second portion TP12A relative to the first portion TP11A about the axis Ax5, perpendicular to the axis Ax4A, as a rotation axis. The rotational direction Dr5 shown in FIG. 1 indicates a rotational direction of the second portion TP12A when the axis Ax5 rotates as the rotation axis.

The joint mechanism JEr6 is identical to that shown in FIG. 1. In one example, the joint mechanism JEr6 rotates at least a portion (e.g., an end face TP1sf) of the end section TP1B about an axis Ax6 as a rotation axis. The axis Ax6 is perpendicular to the axis Ax5. In one example shown in FIG. 22, an end surface TP1sf is included in the front surface of the joint mechanism JEr6. The second portion TP12A and the joint mechanism JEr6 may be unitary.

In the foregoing modification, the joint mechanism JEr4B rotates the end section TP1B relative to the link LK2B about the axis Ax4A as a fourth rotation axis. The axis Ax4A forms an angle equal to or less than the predetermined with the direction De2. The end section TP1B includes the first portion TP11A connected to the link LK2B, the second portion TP12A connected to the first portion TP11A, the joint mechanism JEr5A, and the joint mechanism JEr6. The joint mechanism JEr5A connects the first portion TP11A and the second portion TP12A to each other. The joint mechanism JEr5A rotates the second portion TP12A relative to the first portion TP11A about the axis Ax5 as a fifth rotation axis. The axis Ax5 forms an angle equal to or greater than the predetermined angle with the fourth rotation axis. The joint mechanism JEr6 rotates at least a portion of the end section TP1B about the axis Ax6 as a sixth rotation axis. The axis Ax6 forms an angle equal to or greater than the predetermined angle with the fifth rotation axis. This modification also provides the same effects as those of the foregoing embodiment.

### Third Modification

In the foregoing embodiment and modifications, an example is given of the articulated robot 10 with six rotary joints and two prismatic joints. However, his disclosure is not limited to such aspects. In one example, the robot 10 may have eight-axes, nine-axes, or more. This modification also provides the same effects as those of the foregoing embodiment and modifications.

### 3. Use Example

The robot system 1 including the robot 10, described in the foregoing embodiment and modifications, may be used in a method for manufacturing an object, in which the manufacturing includes assembling components or removing components.

### 4. Other Matters

Some examples will be given of “turning” and “rotation,” which are distinguished from each other, as briefly described in the foregoing embodiments.

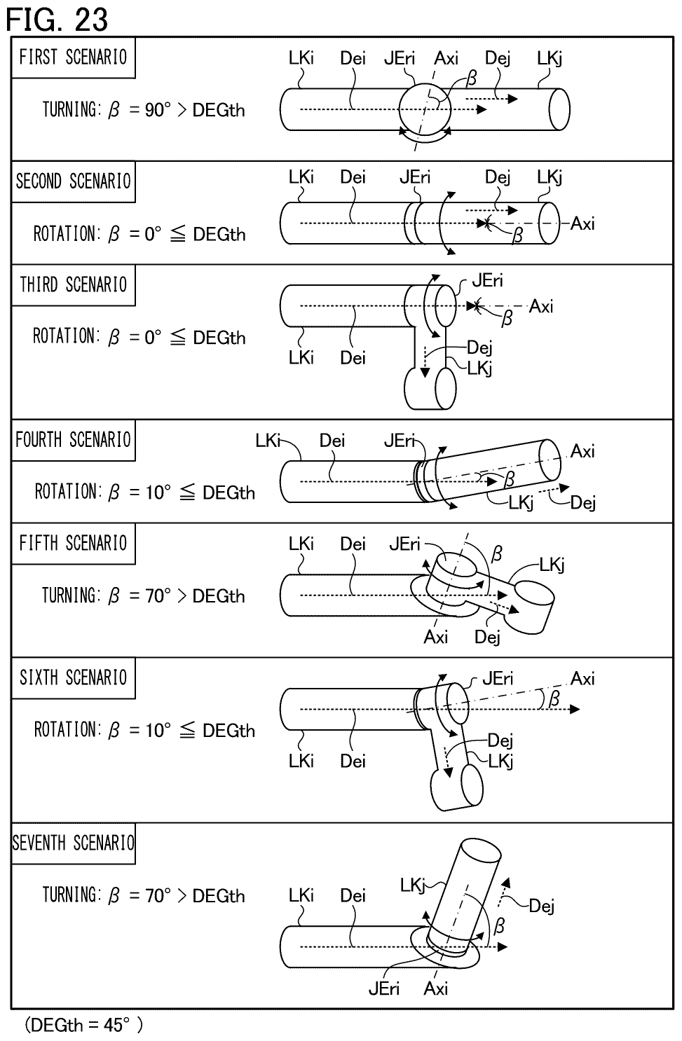

FIG. 23 illustrates description of “turning.” In FIG. 23, “turning” and “rotation,” which are distinguished from each other, will be described with reference to connection between two links LKi and LKj in the longitudinal direction. As shown in FIG. 23, a direction Dei of extension indicates a direction of extension of the link LKi. A direction Dej of extension indicates a direction of extension of the LKj. A joint mechanism JEri shown in FIG. 23 connects the link LKi and the link LKj to each other. The joint mechanism JEri rotates the link LKj relative to the link LKi about an axis Axi as a rotation axis.

In the example shown in FIG. 23, when an angle β is greater than a predetermined angle, rotation about the axis Axi means “turning.” The angle β is formed between the direction Dei of extension of the link LKi (a specific direction) and the axis Axi. In other words, when the angle β is equal to or less than the predetermined angle, rotation about the axis Axi means “rotation other than turning (rotation distinguished from turning).” The “rotation” shown in FIG. 23 represents “rotation other than turning.” Although the predetermined angle is not limited thereto, it is envisaged that the predetermined angle is 45° as shown in FIG. 23. The angle β is 0° or more and 90° or less. The angle β is one of the angles that are recognized as the angle of the axis Axi relative to the direction Dei of extension (e.g., four angles formed by two straight lines crossing each other, or 0° and 180° formed by two straight lines parallel to each other).

In a first scenario, the angleβ, which is between the direction Dei of extension of the link LKi and the axis Axi, is 90° and is greater than the predetermined angle) (45°. Rotation of the link LKj about the axis Axi in the first scenario means “turning.” Furthermore, the direction Dej of extension of the link LKj is perpendicular to the axis Axi. In the first scenario, when the link LKj is rotated (turned) about the axis Axi as a rotation axis, an angle between the direction Dej of extension of the link LKj and the direction Dei of extension of the link LKi changes.

In a second scenario, the angleβ, which is between the direction Dei of extension of the link LKi and the axis Axi, is 0° and is equal to or less than the predetermined angle) (45°. Rotation of the link LKj about the axis Axi as a rotation angle in the second scenario means “rotation other than turning.” In the second scenario, the direction Dej of extension of the link LKj is parallel to both the direction Dei of extension of the link LKi and the axis Axi. In other words, an angle between the direction Dej of extension of the link LKj to the direction Dei of extension of the link LKi is 0°. In the second scenario, the angle is maintained at 0°, and this is constant even when the link LKj is rotated about the axis Axi as a rotation axis.

In a third scenario, the angleβ, which is between the direction Dei in which the link LKi extends and the axis Axi, is 0° and is equal to or less than the predetermined angle) (45°. Rotation of the link LKj about the axis Axi as a rotation axis in the third scenario means “rotation other than turning.”

Furthermore, the direction Dej of extension of the link LKj is perpendicular to both the direction Dei of extension of the link LKi and the axis Axi. In other words, the angle between the direction Dej of extension of the link LKj and the direction Dei of extension of the link LKi is 90°. In the third scenario, the angle is maintained at 90° and is constant, even when the link LKj is rotated about the axis Axi as a rotation axis.

In a fourth scenario, the angle B, which is between the direction Dei of extension of the link LKi and the axis Axi, is 10° and is equal to or less than the predetermined angle) (45°. Rotation of the link LKj about the axis Axi in the fourth scenario means “rotation other than turning.”

Furthermore, the direction Dej of extension of the link LKj is parallel to the axis Axi. The angle between the direction Dej of extension of the link LKj and the direction Dei of extension of the link LKi is 10°. In the fourth scenario, the angle is maintained at 10° and is constant, even when the link LKj is rotated about the axis Axi as a rotation axis.

In a fifth scenario, the angle B, which is between the direction Dei of extension of the link LKi and the axis Axi, is 70° and is greater than the predetermined angle) (45°. Rotation of the link LKj about the axis Axi in the fifth scenario means “turning,” and the direction Dej of extension of the link LKj is perpendicular to the axis Axi. In the fifth scenario, when the link LKj is rotated (turned) about the axis Axi as a rotation axis, the angle, which is between the direction Dej of extension of the link LKj and the direction Dei of extension of the link LKi, changes.

In a sixth scenario, the angle B, which is between the direction Dei of extension of the link LKi and the axis Axi, is 10° and is equal to or less than the predetermined angle) (45°. Rotation of the link LKj about the axis Axi as a rotation axis in the sixth scenario means “rotation other than turning,” and the direction Dej of extension of the link LKj is perpendicular to the axis Axi. In the sixth scenario, when the link LKj is rotated about the axis Axi as a rotation axis, the angle, which is between the direction Dej of extension of the link LKj and the direction Dei of extension of the link LKi, changes.

In a seventh scenario, the angleβ, which is between the direction Dei of extension of the link LKi and the axis Axi, is 70° and is greater than the predetermined angle) (45°. Rotation of the link LKj about the axis Axi in the seventh scenario means “turning.”

Furthermore, the direction Dej of extension of the link LKj is parallel to the axis Axi. The angle, which is between the direction Dej of extension of the link LKj and the direction Dei of extension of the link LKi is 70°. In the seventh scenario, the angle is maintained at 70° and is constant, even when the link LKj is rotated about the axis Axi as a rotation axis.

Thus, in the foregoing embodiment and modifications, rotation called “turning” is rotation about the axis Axi that is one of a variety of types of rotation of the link LKj relative to the link LKi and forms an angle greater than the predetermined angle with the direction Dei of extension of the link LKi. However, the definition of “turning” is not limited to such examples. For example, when the foregoing definition (rotation about the axis Axi, which forms an angle greater than the predetermined angle with the direction Dei of extension of the link LKi, is “turning”) is referred to as a first definition, the following second definition or third definition may be employed in place of the first definition.

In the second definition, when the angle, which is between the direction Dej of extension of the link LKj and the direction Dei of extension of the link LKi, changes by rotation of the link LKj relative to the link LKi, such a rotation means “turning.” As a result, in the second definition, when the angle is constant even if the link LKj is rotated, such a rotation means “rotation other than turning.” In one example, in the second definition, the first, fifth, and sixth scenarios shown in FIG. 23 means “turning.” The second, third, fourth, and seventh scenarios means “rotation other than turning.”

In the third definition, when the angle, which is between the direction Dej of extension of the link LKj and the rotation axis (the axis Axi) of the link LKj, is greater than a predetermined angle, such rotation means “turning.” As a result, in the third definition, when the angle is equal to or less than the predetermined angle, such rotation means “rotation other than turning.” In one example, in the third definition, the first, third, fifth, and sixth scenarios shown in FIG. 23 means “turning.” The second, fourth, and seventh scenarios means “rotation other than turning.”

Separately from the first, second, and third definitions, a relative relationship between two types of rotation by two joint mechanisms JEr adjacent to each other may be defined based on a relationship between rotation axes of the two joint mechanisms JEr. Specifically, when an angle between the two rotation axes is equal to or less than a predetermined angle (typically, the two rotation axes are parallel to each other), the two types of rotation may be defined as the same type of rotation. When the angle is greater than the predetermined angle (typically, the two rotation axes are perpendicular to each other), the two type of rotation may be defined as different types of rotation. The phrase “the same type of rotation” means that both the two types of rotation are “turning” or both the two types of rotation are “rotation other than turning.” The phrase “the different types of rotation” means that one of the two types of rotation is “turning,” and the other is “rotation other than turning.” When the definition of the relative relationships between the two types of rotation is used, rotation serving as the origin of the relative relation may be determined based on, for example, any of the first, second, and third definitions. The first scenario shown in FIG. 23 corresponds to “turning” in all of the first, second, and third definitions. The second scenario corresponds to “rotation other than turning” in all of the first, second, and third definitions. As a result, the first or second scenario is used as rotation serving as the origin of the relative relation.

A definition obtained by combining two or more of the first, second, and third definitions may be used. In this case, for example, only rotation corresponding to turning in all of the two or more definitions to be combined may be “turning.” Alternatively, “rotation corresponding to turning” in at least one of the two or more definitions to be combined may be “turning.”

### DESCRIPTION OF REFERENCE SIGNS

1 . . . robotic system, 10 . . . robot, 20 . . . end effector, 30 . . . robot controller, 32 . . . processing device, 33 . . . motion controller, 35 . . . memory, 36 . . . communicator, 37 . . . input operation device, 38 . . . display, 39 . . . driver circuit, Ax1, Ax2, Ax3, Ax4, Ax4A, Ax5, Ax6, Axi . . . axis, BDP, BDPa . . . base body, BDPbt . . . bottom surface, BDPba . . . base part, JEe1, JEe2, JEp1, JEp2, JEr1, JEr2, JEr3, JEr3A, JEr4, JEr4A, JEr5, JEr5A, JEr6, JEri . . . joint mechanism, LK1, LK1A, LK2, LK2A, LKi, LKj . . . link, LK1a, LK2a . . . support portion, LK1b, LK1c, LK2b, LK2c . . . movable portion, MOr1, MOr2, MOr3, MOr4, MOr5, MOr6, MOp1, MOp2 . . . motor.

What is claimed is:

1. A method for controlling an articulated robot with seven or more joints, the method comprising:
repeating unit processing including:
computation processing for:
computing a displacement of each of the seven or more joints by use of computation of inverse kinematics; and
updating a joint value of each of the seven or more joints based on the computed displacement thereof; and
fixation processing to be performed on a joint in a specific state from among the seven or more joints, wherein the specific state is determined based on a joint value of the joint in the specific state,
wherein when the fixation processing is performed, the computation processing includes changing, from among the seven or more joints, joint values of respective joints in a non-specific state, without substantially changing the joint value of the joint in the specific state.

2. The method for controlling the articulated robot according to claim 1, wherein the joint value of the joint in the specific state takes, within a range of motion for the joint, a value of a boundary range between an inside and outside of the range of motion.

3. The method for controlling the articulated robot according to claim 1, wherein:
the updating in previous unit processing updates joint values of the seven or more joints to first joint values,
when the joint in the specific state is included in the seven or more joints, the unit processing further includes:
returning the updated first joint values by the previous unit processing to pre-updated second joint values;
identifying, based on the updated first joint values, the joint in the specific state to be subjected to the fixation processing; and
performing the computation processing after the fixation processing.

4. The method for controlling the articulated robot according to claim 1, further comprising changing the joint value of the joint in the specific state,
wherein, when the joint in the specific state is included in the seven or more joints in an initial state, the initial state coming before repetition of the unit processing,
the changing changes the joint value of the joint in the specific state to a joint value corresponding to the non-specific state before first-time unit processing of the repeated unit processing.

5. The method for controlling the articulated robot according to claim 1, wherein:
the computation processing includes computing the displacement of the each of the seven or more joints by performing the computation of inverse kinematics with a Jacobian matrix including multiple elements,
the fixation processing includes setting, from among the multiple elements for the Jacobian matrix, an element of the joint in the specific state to a value of substantially zero, to remain the joint value of the joint in the specific state unchanged.

6. The method for controlling the articulated robot according to claim 1, wherein the joints include at least one prismatic joint.

7. A robot system comprising:
an articulated robot with seven or more joints; and
a controller configured to control operation of the articulated robot, wherein:
the controller includes:
at least one memory storing a program; and
at least one processor that executes the program to at least:
repeat unit processing including:
computation processing for:
computing a displacement of each of the seven or more joints by use of computation of inverse kinematics; and
updating a joint value of each of the seven or more joints based on the computed displacement thereof; and
fixation processing to be performed on a joint in a specific state from among the seven or more joints, wherein the specific state is determined based on a joint value of the joint in the specific state,
when the fixation processing is performed, the at least one processor further executes the program to change in the computation processing, from among the seven or more joints, joint values of respective joints in a non-specific state, without substantially changing the joint value of the joint in the specific state.

8. The robot system according to claim 7, wherein:
the articulated robot includes:
a base;
a first link;
a second link;
an end section;
a first driving mechanism configured to rotate at least a portion of the base about a first rotation axis, the first rotation axis forming an angle equal to or less than a predetermined angle with a direction perpendicular to a bottom surface of the base;
a second driving mechanism connecting the base and the first link to each other, and configured to rotate the first link about a second rotation axis, the second rotation axis forming an angle greater than the predetermined angle with the direction perpendicular to the bottom surface of the base;
a third driving mechanism connecting the first link and the second link to each other, and configured to rotate the second link relative to the first link about a third rotation axis, the third rotation axis forming an angle greater than the predetermined angle with a first direction of extension of the first link;
a fourth driving mechanism connecting the second link and the end section to each other, and configured to rotate the end section relative to the second link about a fourth rotation axis, the fourth rotation axis forming an angle greater than the predetermined angle with a second direction of extension of the second link;
a first moving mechanism configured to move the third driving mechanism relative to the first link along the first direction of extension of the first link; and
a second moving mechanism configured to move the second link relative to the third driving mechanism along the second direction of extension of the second link,
the end section includes:
a first portion connected to the second link;
a second portion connected to the first portion;
a fifth driving mechanism connecting the first portion and the second portion to each other, and configured to rotate the second portion relative to the first portion about an axis as a fifth rotation axis, the axis as the fifth rotation axis forming an angle greater than the predetermined angle with the fourth rotation axis; and
a sixth driving mechanism configured to rotate at least a portion of the end section about an axis as a sixth rotation axis, the axis as the sixth rotation axis forming an angle greater than the predetermined angle with the fifth rotation axis, and
the seven or more joints include:
the first driving mechanism;
the second driving mechanism;
the third driving mechanism;
the fourth driving mechanism;
the fifth driving mechanism;
the sixth driving mechanism;
the first moving mechanism; and
the second moving mechanism.

9. The robot system according to claim 7, wherein:
the articulated robot includes:
a base;
a first link including a first support portion and a first movable portion;
a second link including a second support portion and a second movable portion;
an end section;
a first driving mechanism configured to rotate at least a portion of the base about a first rotation axis, the first rotation axis forming an angle equal to or less than a predetermined angle with a direction perpendicular to a bottom surface of the base;
a second driving mechanism connecting the base and the first support portion to each other, and configured to rotate the first link relative to the base about a second rotation axis, the second rotation axis forming an angle greater than the predetermined angle with the direction perpendicular to the bottom surface of the base;
a third driving mechanism connecting the first movable portion and the second support portion to each other, and configured to rotate the second link relative to the first link about a third rotation axis, the third rotation axis forming an angle greater than the predetermined angle with a first direction of extension of the first link;
a fourth driving mechanism configured to rotate the second movable portion relative to the second support portion about a fourth rotation axis, the fourth rotation axis forming an angle equal to or less than the predetermined angle with a second direction of extension of the second link;
a fifth driving mechanism connecting the second movable portion and the end section to each other, and configured to rotate the end section relative to the second link about a fifth rotation axis, the fifth rotation axis forming an angle greater than the predetermined angle with the second direction of extension of the second link;
a sixth driving mechanism configured to rotate at least a portion of the end section relative to the second link about a sixth rotation axis, the sixth rotation axis forming an angle greater than the predetermined angle with the fifth rotation axis;
a first mechanism configured to extend and retract the first link by moving the first movable portion relative to the first support portion along the first direction of extension of the first link; and
a second mechanism configured to extend and retract the second link by moving the second movable portion relative to the second support portion along the second direction of extension of the second link, and
the seven or more joints include:
the first driving mechanism;
the second driving mechanism;
the third driving mechanism;
the fourth driving mechanism;
the fifth driving mechanism;
the sixth driving mechanism;
the first mechanism; and
the second mechanism.

10. The robot system according to claim 7, wherein:
the articulated robot includes:
a base;
a first link;
a second link;
an end section;
a first driving mechanism configured to rotate at least a portion of the base about a first rotation axis, the first rotation axis forming an angle equal to or less than a predetermined angle with a direction perpendicular to a bottom surface of the base;
a second driving mechanism connecting the base and the first link to each other, and configured to rotate the first link about a second rotation axis, the second rotation axis forming an angle greater than the predetermined angle with the direction perpendicular to the bottom surface of the base;
a third driving mechanism connecting the first link and the second link to each other, and configured to rotate the second link relative to the first link about a third rotation axis, the third rotation axis forming an angle greater than the predetermined angle with a first direction of extension of the first link;
a fourth driving mechanism connecting the second link and the end section to each other, configured to rotate the end section relative to the second link about a fourth rotation axis, the fourth rotation axis forming an angle equal to or less than the predetermined angle with a second direction of extension of the second link;
a first moving mechanism configured to move the third driving mechanism relative to the first link along the first direction of extension of the first link; and
a second moving mechanism configured to move the second link relative to the third driving mechanism along the second direction of extension of the second link,
the end section includes:
a first portion connected to the second link;
a second portion connected to the first portion;
a fifth driving mechanism connecting the first portion and the second portion to each other, configured to rotate the second portion relative to the first portion about a fifth rotation axis, the fifth rotation axis forming an angle greater than the predetermined angle with the fourth rotation axis; and
a sixth driving mechanism configured to rotate at least a portion of the end section about a sixth rotation axis, the sixth rotation axis forming an angle greater than the predetermined angle with the fifth rotation axis, and
the seven or more joints include:
the first driving mechanism;
the second driving mechanism;
the third driving mechanism;
the fourth driving mechanism;
the fifth driving mechanism;
the sixth driving mechanism;
the first moving mechanism; and
the second moving mechanism.

11. A method for manufacturing an object, comprising assembling or removing a component by the robot system according to claim 7.

12. A non-transitory computer readable recording medium storing a program executable by at least one processor to execute a method for controlling an articulated robot with seven or more joints, the method comprising:
repeating unit processing including:
computation processing for:
computing a displacement of each of the seven or more joints by use of computation of inverse kinematics; and
updating a joint value of each of the seven or more joints based on the computed displacement thereof; and
fixation processing to be performed on a joint in a specific state from among the seven or more joints, wherein the specific state is determined based on a joint value of the joint in the specific state,
wherein, when the fixation processing is performed, the computation processing includes changing, from among the seven or more joints, joint values of respective joints in a non-specific state, without substantially changing the joint value of the joint in the specific state.
